(19) United States
(12) Patent Application Publication
(10) Pub. No.: US 2006/0069876 A1
(43) Pub. Date: Mar. 30, 2006

(54) Method and system of clock with adaptive cache replacement and temporal filtering

(76) Inventors: Sorav Bansal, Stanford, CA (US); Dharmendra Shantilal Modha, San Jose, CA (US)

Correspondence Address: FREDERICK W. GIBB, III;GIBB INTELLECTUAL PROPERTY LAW FIRM, LLC, 2568-A RIVA ROAD, SUITE 304, ANNAPOLIS, MD, 21401, US

(21) Appl. No.: 10/955,201

(22) Filed: Sep. 30, 2004

(51) Int. Cl. G06F 12/00

(52) U.S. Cl. 711/134

(57) ABSTRACT

A method and system of managing data retrieval in a computer comprising a cache memory and auxiliary memory comprises organizing pages in the cache memory into a first and second clock list, wherein the first clock list comprises pages with short-term utility and the second clock list comprises pages with long-term utility; requesting retrieval of a particular page in the computer; identifying requested pages located in the cache memory as a cache hit; transferring requested pages located in the auxiliary memory to the first clock list; relocating the transferred requested pages into the second clock list upon achieving at least two consecutive cache hits of the transferred requested page; logging a history of pages evicted from the cache memory; and adaptively varying a proportion of pages marked as short and long-term utility to increase a cache hit ratio of the cache memory by utilizing the logged history of evicted pages.

### CROSS-REFERENCE TO RELATED APPLICATION

This application is related to pending U.S. patent application Ser. No. 10/690,303, filed Oct. 21, 2003, and entitled, “Method and System of Adaptive Replacement Cache with Temporal Filtering,” the complete disclosure of which, in its entirety, is herein incorporated by reference.

### BACKGROUND OF THE INVENTION

1. Field of the Invention

The embodiments of the invention generally relate to cache operations within computer systems, and more particularly to an adaptive cache replacement technique with enhanced temporal filtering in a demand paging environment.

2. Description of the Related Art

Caching is a fundamental problem in computer science. Modern computational infrastructure designs are rich in examples of memory hierarchies where a fast, but expensive main (“cache”) memory is placed in front of an inexpensive, but slow auxiliary memory. Caching methodologies manage the contents of the cache so as to improve the overall performance. In particular, caching methodologies are of tremendous interest in databases, virtual memory management, and storage systems, etc., where the cache is RAM and the auxiliary memory is a disk subsystem.

For simplicity, it is assumed that both the cache and the auxiliary memory are managed in discrete, uniformly-sized units called “pages”. If a requested page is present in the cache, then it can be served quickly resulting in a “cache hit”. On the other hand, if a requested page is not present in the cache, then it must be retrieved from the auxiliary memory resulting in a “cache miss”. Usually, latency on a cache miss is significantly higher than that on a cache hit. Hence, caching methodologies focus on improving the hit ratio. Historically, the assumption of “demand paging” has been used to study caching methodologies. Under demand paging, a page is retrieved from the auxiliary memory to the cache only on a cache miss. In other words, demand paging precludes speculatively pre-fetching pages. Under demand paging, the only question of interest is: When the cache is full, and a new page must be inserted in the cache, which page should be replaced? Currently, the best offline cache replacement policy is the so-called “MIN” technique developed by Laszlo A. Belady, which replaces the page that is used farthest in the future.

Digital microprocessors use cache memory to hold data likely to be needed in the near future. Cache memory is comparatively fast and is on local memory. Caching usually occurs when data or other instructions are retrieved from the main memory to be used by the microprocessor, and are also stored in the cache. Typically, the cache is constructed from a random access, read/write memory block (RAM), which can access a single stored object, referred to as a line, in a single processor cycle. Preferably, the cache size matches the processor cycle time and is read or written during a given cycle. A server can be configured to receive a stream of requests from clients in a network system to read from or write to a disk drive in the server. These requests form the “workload” for the server.

Each line in the cache memory contains the data being saved and the address of the data in the main memory (the tag). An example of a simple cache 210 is illustrated in the block diagram of FIG. 1. When the microprocessor makes a reference to the main memory, a part of the reference address, referred to as the index, accesses a single line stored in the cache RAM 212. A “hit” occurs if the tag of the accessed line in the cache 210 matches the reference address of the referenced data. When this happens, the cache RAM 212 immediately supplies the line to the microprocessor. However, a “miss” occurs if the tag of the accessed line in the cache 210 does not match the reference address of the referenced data. When this happens, the address is sent to the main memory to retrieve the requested line. When the main memory sends the line to the microprocessor, it is written into the cache RAM 212 using the same index as the original look-up, along with its tag. However, because the main memory is much slower than the microprocessor, a delay occurs during this retrieval process.

Additionally, cache memory is used when data is written from a host computer to a long-term data storage device such as a disk drive. Here, data may be written to cache memory in which it is temporarily held with an indication that the data must be written to longer term data storage when the data storage system is able to perform this write operation. When cache memory is used to temporarily delay writing pending data, memory storage locations are removed from the main memory locations generally available to the data storage system in which data may be held pending use by the host.

Traditionally, under the assumption of demand paging, a cache technique termed the least recently used (LRU) has been used. This popular online policy imitates the MIN technique by replacing the LRU page. When the cache is full, and a page must be demoted to make space for a new page, LRU removes the least recently used page from the cache. The technique LRU is simple to implement, has constant time and space overhead, and it captures “clustered locality of reference” or “recency” property of workloads. However, LRU has three main disadvantages: (i) it does not capture pages with “high frequency” or “long-term-utility”; (ii) it is not resistant to scans which are a sequence of one-time-use-only read/write requests; and (iii) on every hit to a cache page it must be moved to the most recently used (MRU) position. In an asynchronous computing environment where multiple threads may be trying to move pages to the MRU position, the MRU position is protected by a lock to ensure consistency and correctness. This lock typically leads to a great amount of contention, since all cache hits are serialized behind this lock. Such contention is often unacceptable in high performance and high throughput environments such as virtual memory, databases, file systems, and storage controllers.

Other disadvantages of the LRU technique are that in a virtual memory setting, the overhead of moving a page to the MRU position on every page hit is unacceptable, and while LRU captures the “recency” features of a workload, it does not capture and exploit the “frequency” features of a workload. More generally, if some pages are often re-requested, but the temporal distance between consecutive requests is larger than the cache size, then LRU cannot take advantage of such pages with “long-term utility”. Moreover, LRU can be easily polluted by a scan, that is, by a sequence of one-time use only page requests leading to lower performance.

Recently, under the assumption of demand paging, a caching technique termed the Adaptive Replacement Cache (ARC) has been used (Nimrod Megiddo and D. S. Modha, ARC: A Self-tuning, Low Overhead Replacement Cache, Proc. 2nd USENIX Conference on File and Storage Technologies (FAST 03), San Francisco, Calif., 115-130, 2003), the complete disclosure of which, in its entirety, is herein incorporated by reference. Comparatively, this caching technique has low computational overhead similar to LRU updating schemes, its space overhead over LRU is negligible, it outperforms LRU for a wide range of workloads and cache sizes, it is self-tuning in that for every workload it dynamically adapts between recency and frequency to increase the hit ratio, and it is scan-resistant, and, hence, avoids cache pollution due to sequential workloads.

The basic idea behind ARC is that the cache is managed in uniform-sized chunks called “pages”. Assuming that the cache can hold c pages, the ARC technique maintains a cache directory that contains 2c pages—c pages in the cache and c history pages. The cache directory of ARC, which is referred to as DBL, maintains two lists: L₁ and L₂. The first list contains pages that have been seen only once recently, while the latter contains pages that have been seen at least twice recently. The replacement technique for managing DBL is: Replace the LRU page in L₁, if |L₁|=c; otherwise, replace the LRU page in L₂. The ARC technique builds on DBL by carefully selecting c pages from the 2c pages in DBL. The basic idea is to divide L₁ into top T₁ and bottom B₁ and to divide L₂ into top T₂ and bottom B₂. The pages in T₁ (resp. T₂) are more recent than those in B₁ (resp. B₂). The methodology sets a target size p for the list T₁. The replacement technique is as follows: Replace the LRU page in T₁, if |T₁|≧p; otherwise, replace the LRU page in T₂. The adaptation comes from the fact that the target size p is continuously varied in response to an observed workload. The adaptation rule is as follows: Increase p, if a hit in the history B₁ is observed; similarly, decrease p, if a hit in the history B₁ is observed.

However, a limitation of ARC is that whenever it observes a hit on a page in L₁=T₁∪B₁, it immediately promotes the page to L₂=T₂∪B₂ because the page has now been recently seen twice. At an upper level of memory hierarchy, ARC observes two or more successive references to the same page fairly quickly. Such quick successive hits are known as “correlated references” and are not a guarantee of long-term utility of a page, and, hence, such pages pollute L₂, thus reducing system performance. Therefore, there is a need to create a temporal filter that imposes a more stringent test for promotion from L₁ to L₂. Such a temporal filter is of extreme importance in upper levels of memory hierarchy such as file systems, virtual memory, databases, etc.

The Independent Reference Model (IRM) captures the notion of frequencies of page references. Under the IRM, the requests at different times are stochastically independent. LFU replaces the least frequently used page and is optimal under the IRM but has several potential drawbacks: (i) its running time per request is logarithmic in the cache size; (ii) it is oblivious to recent history; and (iii) it does not adapt well to variable access patterns, wherein it accumulates stale pages with past high frequency counts, which may no longer be useful.

The last fifteen years have seen development of a number of novel caching methodologies that have attempted to combine “recency” (LRU) and “frequency” (LFU) with the intent of removing one or more disadvantages of LRU. Chronologically, FBR, LRU-2, 2Q, RFU, MQ, and LIRS have been proposed. Unfortunately, each of these techniques poses some prohibitive disadvantages. The ARC technique was introduced to eliminate essentially all of the drawbacks of the above mentioned policies, and further, is self-tuning, requires low overhead, is scan resistant, and has performance characteristics similar to or better than LRU, LFU, FBR, LRU-2, 2Q, MQ, LRFU, and LIRS, even when some of these policies are allowed to select the best, offline values for their tunable parameters, without any need for pre-tuning or user-specified magic parameters. A minor disadvantage of LRU is that it cannot detect loping patterns. This persists in most of the above mentioned cache replacement methodologies, including ARC.

The CLOCK methodology was developed specifically for low-overhead, low-lock contention environments. Perhaps the oldest methodology along these lines was the First-In First-Out (FIFO) approach that simply maintains a list of all pages in the cache such that head of the list is the oldest arrival and tail of the list is the most recent arrival. However, due to much lower performance than LRU, FIFO in its original form is seldom used today.

Second chance (SC) is a simple, but extremely effective enhancement to FIFO, where a page reference bit is maintained with each page in the cache while maintaining the pages in a FIFO queue. When a page arrives in the cache, it is appended to the tail of the queue and its reference bit set to zero. Upon a page hit, the page reference bit is set to one. Whenever a page must be replaced, the policy examines the page at the head of the FIFO queue and replaces it if its page reference bit is zero otherwise the page is moved to the tail and its page reference bit is reset to zero. In the latter case, the replacement policy reexamines the new page at the head of the queue, until a replacement candidate with page reference bit of zero is found.

A key deficiency of SC is that it keeps moving pages from the head of the queue to the tail. This movement makes it somewhat inefficient. CLOCK is functionally identical to SC except that by using a circular queue instead of FIFO it eliminates the need to move a page from the head to the tail. Besides its simplicity, the performance of CLOCK is quite comparable to LRU. CLOCK is a classical cache replacement technique dating back to 1968 that was proposed as a low-complexity approximation to LRU. On every cache hit, the policy LRU needs to move the accessed item to the most recently used position, at which point, to ensure consistency and correctness, it serializes cache hits behind a single global lock. CLOCK eliminates this lock contention, and, hence, can support high concurrency and high throughput environments such as virtual memory and databases. Unfortunately, CLOCK is still plagued by disadvantages of LRU such as disregard for “frequency” and lack of scan-resistance.

A generalized version of CLOCK, namely, GCLOCK, associates a counter with each page that is initialized to a certain value. On a page hit, the counter is incremented. On a page miss, the rotating clock hand sweeps through the clock decrementing counters until a page with a count of zero is found. However, a fundamental disadvantage of GCLOCK is that it requires a counter increment on every page hit which makes it infeasible for virtual memory. There are several other variants of CLOCK, for example, the two-handed clock is used by Solaris® available from Sun Microsystems, Inc., Santa Clara, Calif., USA.

CLOCK maintains a “page reference bit” with every page. When a page is first brought into the cache, its page reference bit is set to zero. The pages in the cache are organized as a circular buffer known as a clock. On a hit to a page, its page reference bit is set to one. Replacement is done by moving a clock hand through the circular buffer. The clock hand can only replace a page with page reference bit set to zero. However, while the clock hand is traversing to find the victim page, if it encounters a page with page reference bit of one, then it resets the bit to zero. Since, on a page hit, there is no need to move the page to the MRU position, no serialization of hits occurs. Moreover, in virtual memory applications, the page reference bit can be turned on by the hardware. Furthermore, the performance of CLOCK is usually quite comparable to LRU.

A recent breakthrough generalization of LRU, namely, Adaptive Replacement Cache (ARC), removes some of the disadvantages associated with LRU. The ARC methodology is scan-resistant, exploits both the recency and the frequency features of the workload in a self-tuning fashion, has low space and time complexity, and outperforms LRU across a wide range of workloads and cache sizes. Furthermore, ARC, which is self-tuning, also has performance characteristics comparable to a number of other state of-the-art policies even when these policies are allowed the best, offline values for their tunable parameters.

As previously indicated, the CLOCK technique removes some of the disadvantages associated with LRU, while ARC removes other disadvantages associated with LRU. However, there remains a need for a novel page caching technique which removes all of the disadvantages associated with LRU. Thus, while numerous page caching techniques have been developed through the years, there remains a need for an improved page caching technique which overcomes all of the disadvantages of all of the conventional techniques, and which can be implemented easily and efficiently.

### SUMMARY OF THE INVENTION

In view of the foregoing, an embodiment of the invention provides a method of managing data retrieval in a computer system comprising a cache memory and an auxiliary memory, wherein the method comprises organizing pages in the cache memory into a first clock list and a second clock list, wherein the first clock list comprises pages with short-term utility and the second clock list comprises pages with long-term utility; requesting retrieval of a particular page in the computer system; identifying requested pages located in the cache memory as a cache hit; transferring requested pages located in the auxiliary memory to the first clock list of the cache memory; relocating the transferred requested pages into the second clock list upon achieving at least two consecutive cache hits of the transferred requested page; logging a history of pages evicted from the cache memory; and adaptively varying a proportion of pages marked as the short-term utility and those marked as the long-term utility to increase a cache hit ratio of the cache memory by utilizing the logged history of evicted pages.

The cache memory is arranged into pages having uniformly-sized units of memory. Also, the process of requesting access to a particular page in the computer system comprises determining whether the particular page is located in the cache memory. The method further comprises maintaining a page reference bit for each page in the cache memory, wherein a new page entering the cache memory comprises a page reference bit of zero, and a page having a cache hit in the cache memory comprises a page reference bit of one.

The method further comprises identifying requested pages located in the auxiliary memory and not in the cache memory as a cache miss, wherein upon identifying the cache miss, the method further comprises evicting a page in either the first clock list or the second clock list if the cache memory is full. Moreover, the method further comprises logging the history of evicted pages into a cache history of the cache memory, wherein the cache history comprises a first list of history pages comprises pages evicted from the first clock list; and a second list of history pages comprises pages evicted from the second clock list.

Furthermore, the method comprises determining whether the requested pages are located in either of the first list of history pages or the second list of history pages; determining whether the cache history is full; evicting a page in the first list of history pages if the transferred requested pages are not located in either of the first list of history pages or the second list of history pages and the cache history is full and a size of the first list of history pages plus a size of the first clock list is equal to a total number of pages in the cache memory; and evicting a page in the second list of history pages if the transferred requested pages are not located in either of the first list of history pages or the second list of history pages and the cache history is full and a size of the first list of history pages plus a size of the first clock list is less than a total number of pages in the cache memory.

Additionally, the method further comprises identifying requested pages located in the auxiliary memory as a cache miss; inserting a transferred requested page at a most recently used (MRU) position in the first clock list; and setting the page reference bit of the transferred requested page to zero. Alternatively, the method further comprises logging the history of evicted pages into a cache history of the cache memory, wherein the cache history comprises a first list of history pages and a second list of history pages; determining whether the requested pages are located in the first list of history pages; establishing a target size of the first clock list; increasing the target size of the first clock list upon a determination that the requested pages are located in the first list of history pages; inserting a transferred requested page at a MRU page position in the second clock list upon a determination that the requested page is located in the first list of history pages; and setting the page reference bit of the transferred requested page to zero.

Still alternatively, the method further comprises logging the history of evicted pages into a cache history of the cache memory, wherein the cache history comprises a first list of history pages and a second list of history pages; determining whether the requested pages are located in the second list of history pages; establishing a target size of the first clock list; decreasing the target size of the first clock list upon a determination that the requested pages are located in the second list of history pages; inserting a transferred requested page at a MRU page position in the second clock list upon a determination that the requested page is located in the second list of history pages; and setting the page reference bit of the transferred requested page to zero.

Yet in another embodiment, the method further comprises logging the history of evicted pages into a cache history of the cache memory, wherein the cache history comprises a first list of history pages and a second list of history pages; identifying a least recently used (LRU) page of the first clock list; evicting the LRU page from the first clock list; and transferring the LRU page to a MRU page position in the first list of history pages if the page reference bit of the LRU page is zero and a size of the first clock list is at least as large as a predetermined target size.

In another embodiment, the method further comprises identifying a LRU page of the first clock list; transferring the LRU page from the first clock list to a MRU page position in the second clock list if the page reference bit of the LRU page is one; and resetting the page reference bit to zero. Alternatively, the method further comprises logging the history of evicted pages into a cache history of the cache memory, wherein the cache history comprises a first list of history pages and a second list of history pages; identifying a LRU page of the second clock list; evicting the LRU page from the second clock list; and transferring the LRU page to a MRU page position in the second list of history pages if the page reference bit of the LRU page is zero and a size of the first clock list is smaller than a predetermined target size. In another alternative embodiment, the method further comprises identifying a LRU page of the second clock list; and transferring the LRU page from the second clock list to a MRU page position in the second clock list if the page reference bit of the LRU page is one.

Another aspect of the invention provides a program storage device readable by computer, tangibly embodying a program of instructions executable by the computer to perform a method of managing data retrieval in a computer system comprising a cache memory and an auxiliary memory.

Yet another aspect of the invention provides a system for adaptively managing data retrieval in a computer, wherein the system comprises a cache memory comprising a first clock list and a second clock list, wherein the first clock list comprises pages with short-term utility and the second clock list comprises pages with long-term utility; a query handler adapted to process requests for retrieval of a particular page in the computer; a processor adapted to identify requested pages located in the cache memory as a cache hit; a first data bus adapted to transfer requested pages located in an auxiliary memory of the system to the first clock list of the cache memory; a second data bus adapted to relocate the transferred requested pages into the second clock list upon achieving at least two consecutive cache hits of the transferred requested page; a cache history comprising pages evicted from the cache memory; and a controller adapted to vary a proportion of pages marked as the short-term utility and those marked as the long-term utility to increase a cache hit ratio of the cache memory by utilizing the logged history of requested pages.

The cache memory is arranged into pages having uniformly-sized units of memory. The query handler is adapted to determine whether the particular page is located in the cache memory. The system further comprises a bit marker comprising a page reference bit for each page in the cache memory, wherein a new page entering the cache memory comprises a page reference bit of zero, and a page having a cache hit in the cache memory comprises a page reference bit of one. Moreover, the system further comprises a classifier adapted to identify requested pages located in the auxiliary memory as a cache miss, wherein upon identifying the cache miss, the system further comprises a purger adapted to delete a page in either the first clock list or the second clock list if the cache memory is full.

Additionally, the cache history comprises a first list of history pages comprises pages evicted from the first clock list; and a second list of history pages comprises pages evicted from the second clock list. The system further comprises means for determining whether the requested pages are located in either of the first list of history pages or the second list of history pages; means for determining whether the cache history is full; means for evicting a page in the first list of history pages if the transferred requested pages are not located in either of the first list of history pages or the second list of history pages and the cache history is full and a size of the first list of history pages plus a size of the first clock list is equal to a total number of pages in the cache memory; and means for evicting a page in the second list of history pages if the transferred requested pages are not located in either of the first list of history pages or the second list of history pages and the cache history is full and a size of the first list of history pages plus a size of the first clock list is less than a total number of pages in the cache memory.

The system further comprises means for identifying requested pages located in the auxiliary memory as a cache miss; means for inserting a transferred requested page at a MRU position in the first clock list; and means for setting the page reference bit of the transferred requested page to zero. Furthermore, the system comprises means for logging the history of evicted pages into a cache history of the cache memory, wherein the cache history comprises a first list of history pages and a second list of history pages; means for determining whether the requested pages are located in the first list of history pages; means for establishing a target size of the first clock list; means for increasing the target size of the first clock list upon a determination that the requested pages are located in the first list of history pages; means for inserting a transferred requested page at a MRU page position in the second clock list upon a determination that the requested page is located in the first list of history pages; and means for setting the page reference bit of the transferred requested page to zero.

Also, the system comprises means for logging the history of evicted pages into a cache history of the cache memory, wherein the cache history comprises a first list of history pages and a second list of history pages; means for determining whether the requested pages are located in the second list of history pages; means for establishing a target size of the first clock list; means for decreasing the target size of the first clock list upon a determination that the requested pages are located in the second list of history pages; means for inserting a transferred requested page at a MRU page position in the second clock list upon a determination that the requested page is located in the second list of history pages; and means for setting the page reference bit of the transferred requested page to zero.

Additionally, the system further comprises means for logging the history of evicted pages into a cache history of the cache memory, wherein the cache history comprises a first list of history pages and a second list of history pages; means for identifying a LRU page of the first clock list; means for evicting the LRU page from the first clock list; and means for transferring the LRU page to a MRU page position in the first list of history pages if the page reference bit of the LRU page is zero and a size of the first clock list is at least as large as a predetermined target size.

Moreover, the system further comprises means for identifying a LRU page of the first clock list; means for transferring the LRU page from the first clock list to a MRU page position in the second clock list if the page reference bit of the LRU page is one; and means for resetting the page reference bit to zero. The system further comprises means for logging the history of evicted pages into a cache history of the cache memory, wherein the cache history comprises a first list of history pages and a second list of history pages; means for identifying a LRU page of the second clock list; means for evicting the LRU page from the second clock list; and means for transferring the LRU page to a MRU page position in the second list of history pages if the page reference bit of the LRU page is zero and a size of the first clock list is smaller than a predetermined target size. Additionally, the system further comprises means for identifying a LRU page of the second clock list; and means for transferring the LRU page from the second clock list to a MRU page position in the second clock list if the page reference bit of the LRU page is one.

Another embodiment of the invention provides a system of managing data retrieval in a computer comprising a cache memory and an auxiliary memory, wherein the system comprises means for organizing pages in the cache memory into a first clock list and a second clock list, wherein the first clock list comprises pages with short-term utility and the second clock list comprises pages with long-term utility; means for requesting retrieval of a particular page in the computer system; means for identifying requested pages located in the cache memory as a cache hit; means for transferring requested pages located in the auxiliary memory to the first clock list of the cache memory; means for relocating the transferred requested pages into the second clock list upon achieving at least two consecutive cache hits of the transferred requested page; means for logging a history of pages evicted from the cache memory; and means for adaptively varying a proportion of pages marked as the short-term utility and those marked as the long-term utility to increase a cache hit ratio of the cache memory by utilizing the logged history of evicted pages.

The embodiments of the invention provide a novel page caching technique, CLOCK with Adaptive Replacement (CAR), which has several advantages over CLOCK including: (i) it is scan-resistant; (ii) it is self-tuning and it adaptively and dynamically captures the “recency” and “frequency” features of a workload; (iii) it uses essentially the seam primitives as CLOCK and, hence, is low-complexity and amenable to a high-concurrency implementation; and (iv) it outperforms CLOCK across a wide-range of cache sizes and workloads. The inventive CAR methodology is derivative of the ARC methodology, and inherits virtually all advantages of ARC including its high performance, but does not serialize cache hits behind a single global lock.

Additionally, the embodiments of the invention provide another page caching technique, CAR with Temporal filtering (CART), which has all the advantages of CAR, but, in addition, uses a certain temporal filter to distill pages with long-term utility from those with only short-term utility.

These and other aspects of embodiments of the invention will be better appreciated and understood when considered in conjunction with the following description and the accompanying drawings. It should be understood, however, that the following description, while indicating preferred embodiments of the invention and numerous specific details thereof, is given by way of illustration and not of limitation. Many changes and modifications may be made within the scope of the embodiments of the invention without departing from the spirit thereof, and the invention includes all such modifications.

### BRIEF DESCRIPTION OF THE DRAWINGS

The embodiments of the invention will be better understood from the following detailed description with reference to the drawings, in which:

FIG. 1 is a schematic diagram of a conventional cache memory system;

FIG. 2 illustrates a page caching technique according to a first embodiment of the invention;

FIG. 3 illustrates a page caching methodology corresponding with the page caching technique of FIG. 2 according to a first embodiment of the invention;

FIG. 4 illustrates a tabular comparison of the conventional page caching techniques and the page caching technique and methodology according to the embodiments of the invention;

FIG. 5 illustrates a page caching methodology according to a second embodiment of the invention;

FIG. 6 illustrates an example of disk accesses arranged as traces according to an embodiment of the invention;

FIG. 7 illustrates a comparison of hit ratios for several page caching techniques;

FIGS. 8(A) through 8(V) are graphical illustrations of hit ratios achieved by the page caching techniques of FIGS. 2, 3, and 5 according to the embodiments of the invention;

FIG. 9 illustrates a comparison of hit ratios for various workloads for several page caching techniques;

FIG. 10 is a graphical illustration of an adaptation parameter p versus the virtual time for the page caching technique of FIGS. 2 and 3 according to an embodiment of the invention;

FIG. 11 is a system diagram according to an embodiment of the invention;

FIG. 12 is a flow diagram illustrating a preferred method of an embodiment of the invention; and

FIG. 13 is a computer architecture diagram according to an embodiment of the invention.

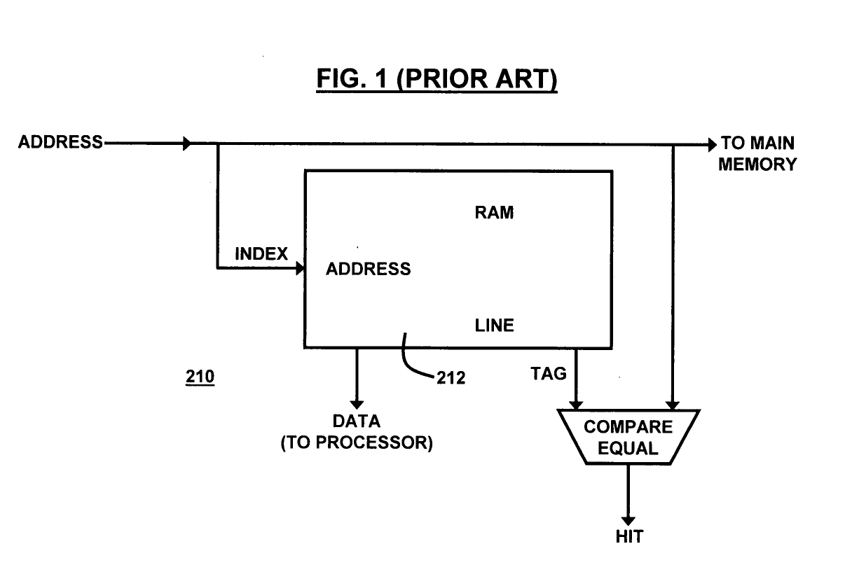

### DETAILED DESCRIPTION OF PREFERRED EMBODIMENTS OF THE INVENTION

The embodiments of the invention and the various features and advantageous details thereof are explained more fully with reference to the non-limiting embodiments that are illustrated in the accompanying drawings and detailed in the following description. It should be noted that the features illustrated in the drawings are not necessarily drawn to scale. Descriptions of well-known components and processing techniques are omitted so as to not unnecessarily obscure the embodiments of the invention. The examples used herein are intended merely to facilitate an understanding of ways in which the embodiments of the invention may be practiced and to further enable those of skill in the art to practice the embodiments of the invention. Accordingly, the examples should not be construed as limiting the scope of the embodiments of the invention.

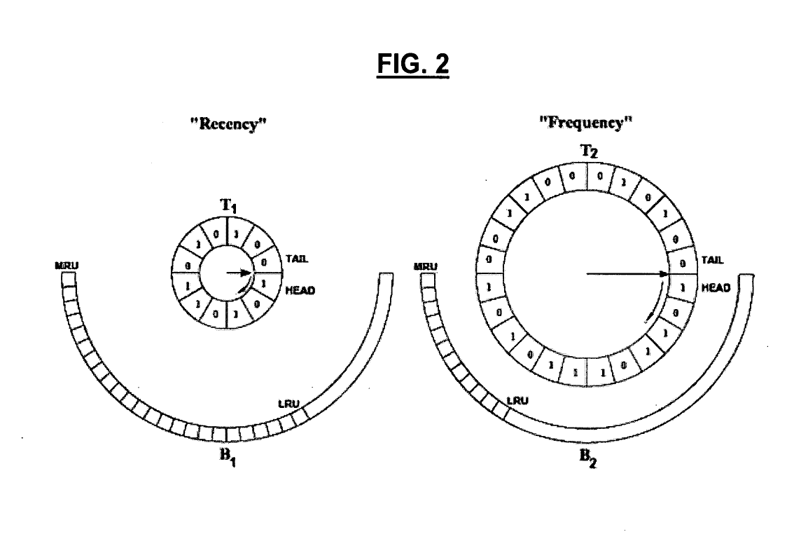

As mentioned, there remains a need for an improved page caching technique which overcomes all of the disadvantages of all of the conventional techniques, and which can be implemented easily and efficiently. The embodiments of the invention address this need by providing the novel CAR (Clock with Adaptive Replacement) and CART (Clock with Adaptive Replacement and Temporal Filtering) caching techniques. Referring now to the drawings and more particularly to FIGS. 2 through 13 where similar reference characters denote corresponding features consistently throughout the figures, there are shown preferred embodiments of the invention.

FIG. 2 illustrates how the CAR technique provided by the embodiments of the invention functions. The CLOCK lists T₁ and T₂ contain those pages that are in the cache and the lists B₁ and B₂ contain history pages that were recently evicted from the cache. The CLOCK list T₁ captures “recency” while the CLOCK list T₂ captures “frequency.” The lists B₁ and B₂ are simple LRU lists. Pages evicted from T₁ are placed on B₁, and those evicted from T₂ are placed on B₂. The methodology provided by the embodiments of the invention strives to keep B₁ to roughly the same size as T₂ and B₂ to roughly the same size as T₁. The algorithm also limits |T₁|+|B₁| from exceeding the cache size. The sizes of the CLOCK lists T₁ and T₂ are adapted continuously in response to a varying workload. Whenever a hit in B₁ is observed, the target size of T₁ is incremented. Similarly, whenever a hit in B₂ is observed, the target size of T₁ is decremented. The new pages are inserted in either T₁ or T₂ immediately behind the clock hands, which are shown in FIG. 2 to rotate clockwise.

The page reference bit of new pages is set to zero. Upon a cache hit to any page in T₁∪T₂, the page reference bit associated with the page is simply set to one. Whenever the T₁ clock hand encounters a page with a page reference bit of one, the clock hand moves the page behind the T₂ clock hand and resets the page reference bit to zero. Whenever the T₁ clock hand encounters a page with a page reference bit of zero, the page is evicted and is placed at the MRU position in B₁. Whenever the T₂ clock hand encounters a page with a page reference bit of one, the page reference bit is reset to zero. Whenever the T₂ clock hand encounters a page with a page reference bit of zero, the page is evicted and is placed at the MRU position in B₂.

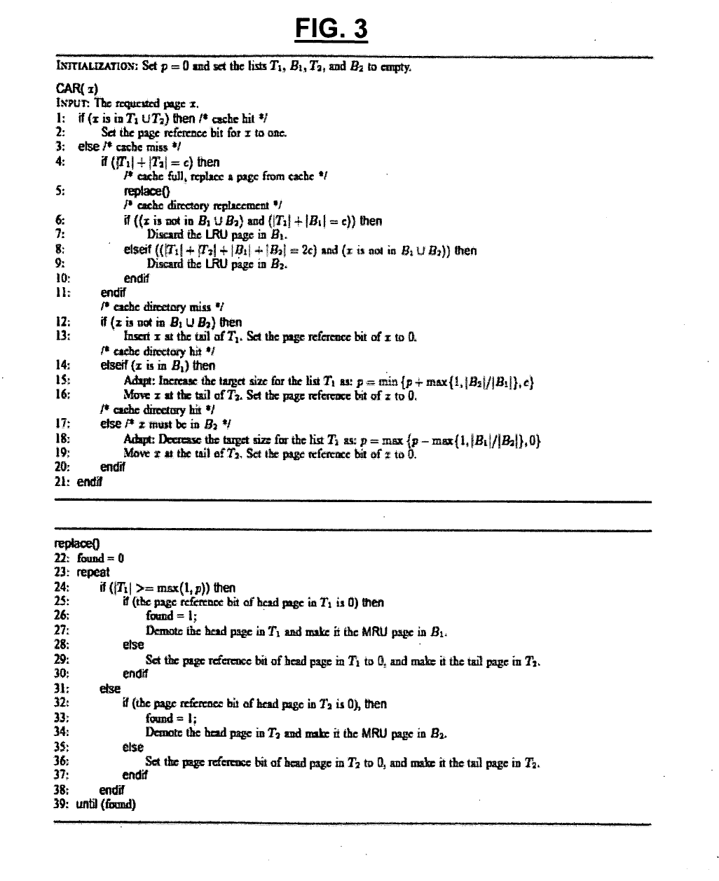

FIG. 3 illustrates the CAR methodology according to a first embodiment of the invention. Given that c denotes the cache size in pages, the CAR technique maintains four doubly linked lists: T₁, T₂, B₁, and B₂. The lists T₁ and T₂ contain the pages in cache, while the lists B₁ and B₂ maintain history information about the recently evicted pages. For each page in the cache, that is, in T₁ or T₂, a page reference bit is maintained that can be set to either one or zero. T₁⁰ denotes the pages in T₁ with a page reference bit of zero and T₁¹ denotes the pages in T₁ with a page reference bit of one.

The four lists are defined as follows. Each page in T₁⁰ and each history page in B₁ has either been requested exactly once since its most recent removal from T₁∪T₂∪B₁∪B₂ or it was requested only once (since inception) and was never removed from T₁∪T₂∪B₁∪B₂ . Each page in T₁¹, each page in T₂, and each history page in B₂ has either been requested more than once since its most recent removal from T₁∪T₂∪B₁∪B₂ or was requested more than once and was never removed from T₁∪T₂∪B₁∪B₂.

Intuitively, T₁⁰∪B₁ contains pages that have been seen exactly once recently whereas T₁¹∪T₂∪B contains pages that have been seen at least twice recently. T₁⁰∪B₁ can be thought of as “recency” or “short-term utility” and T₁¹∪T₂∪B as “frequency” or “long-term utility”. In the methodology in FIG. 3, the lists T₁ and T₂ may be thought of as second chance lists. FIG. 3 depicts T₁ and T₂ as CLOCK lists. The conventional ARC technique employs a strict LRU ordering on the lists T₁ and T₂, whereas the inventive CAR uses a one-bit approximation to LRU, that is, SC. The following invariants may be imposed on these lists:

1) 0≦|T₁|+|T₂|≦c.

2) 0≦|T₁|+|B₁|≦c.

3) 0≦|T₂|+|B₂|≦2c.

4) 0≦|T₁|+|T₂|+|B₁|+|B₂|≦2c.

5) If |T₁|+|T₂|<c, then B₁∪B₂ is empty.

6) If |T₁|+|B₁|+|T₂|+|B₂|≧c, then |T₁|+|T₂|=c.

7) Due to demand paging, once the cache is full, it remains full from then on.

The extra history information contained in lists B₁ and B₂ are used to guide a continual adaptive process that keeps readjusting the sizes of the lists T₁ and T₂. For this purpose, a target size p is maintained for the list T₁. By implication, the target size for the list T₂ is c-p. The extra history leads to a negligible space overhead. The list T₁ may contain pages that are marked either as one or zero. Suppose the list T₁ is scanned from the head towards the tail until a page marked as zero is encountered. T₁ denotes all the pages seen by such a scan, until a page with a page reference bit of zero is encountered. The cache replacement policy provided by CAR is as follows: If T₁\T₁′ contains p or more pages, then a page is removed from T₁, otherwise a page is removed from T₁′∪T₂.

For a better approximation to ARC, the cache replacement policy could be as follows: If T₁⁰ contains p or more pages, then a page is removed from T₁⁰, otherwise a page is removed from T₁¹∪T₂. However, this would require maintaining the list T₁⁰, which seems to entail a much higher overhead on a hit. Hence, the approximate policy is used where T₁′ is used as an approximation to T₁¹.

The cache history replacement policy is as follows: If |T₁|+|B₁| contains exactly c pages, then a history page is removed from B₁, otherwise a history page is removed from B₂. Once again, for a better approximation to ARC, the cache history replacement policy could be written as: If |T₁⁰|+|B₁| contains exactly c pages, then a history page is removed from B₁, otherwise a history page is removed from B₂. However, this would require maintaining the size of T₁⁰ which would require additional processing on a hit, defeating the very purpose of avoiding lock contention.

With regard to the methodology in FIG. 3, line 1 checks whether there is a hit, and if so, then line 2 simply sets the page reference bit to one. There is no MRU operation akin to LRU or ARC involved. Hence, cache hits are not serialized behind a lock and virtually no overhead is involved. As indicated, the MRU operation is delayed until a replacement must be performed (lines 29 and 36). Line 3 checks for a cache miss, and if so, then line 4 checks if the cache is full, and if so, then line 5 carries out the cache replacement by deleting (evicting) a page from either T₁ or T₂. The cache replacement policy “replace( )” is further described below.

If there is a cache miss (line 3), then lines 6-10 examine whether a cache history has to be replaced. In particular, line 6 indicates that if the requested page is totally new; that is, not in B₁ or B₂, and |T₁|+|B₁|=c, then line 7 indicates that a page in B₁ is discarded, (line 8) else if the page is totally new and the cache history is completely full, then (line 9) a page in B₂ is discarded. Finally, if there is a cache miss (line 3), then lines 12-20 carry out movements between the lists and also carry out the adaptation of the target size for T₁. In particular, (line 12) if the requested page is totally new, then (line 13) it is inserted at the tail of T₁ and set its page reference bit to zero, (line 14) else if the requested page is in B₁, then (line 15) the target size is increased for the list T₁ and (line 16) the requested page is inserted at the tail of T₂ and its page reference bit is set to zero. Finally, (line 17) if the requested page is in B₂, then (line 18) the target size is decreased for the list T₁ and (line 19) the requested page is inserted at the tail of T₂ and its page reference bit is set to zero.

With regard to the cache replacement policy (lines 22-39), the cache replacement policy can only replace a page with a page reference bit of zero. Thus, line 22 declares that no such suitable victim page to replace is yet found, and lines 23-39 keep looping until they find such a page. If the size of the list T₁ is at least p and it is not empty (line 24), then the policy examines the head of T₁ as a replacement candidate. If the page reference bit of the page at the head is zero (line 25), then the desired page (line 26) is found, which is demoted from the cache and is moved to the MRU position in B₁ (line 27). Else (line 28), if the page reference bit of the LRU page is one, then the page reference bit is reset to one and the page is moved to the MRU end of T₂ (line 29). Thus, the size of the list T₂ is effectively increased by one, and the size of the list T₁ is decreased by zero.

On the other hand, (line 31) if the size of the list T₁ is less than p, then the policy examines the page at the head of T₂ as a replacement candidate. If the page reference bit of the head page is zero (line 32), then the desired page (line 33) is found, and it can be demoted from the cache and can be moved to the MRU position in B₂ (line 34). Else (line 35), if the page reference bit of the head page is one, then the page reference bit is reset to zero and the page is moved to the tail of T₂ (line 36).

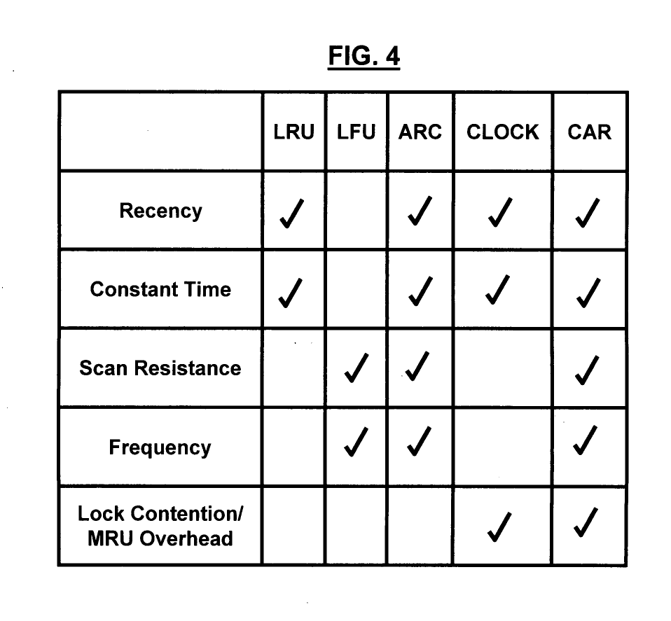

While no MRU operation is needed during a hit, if a page has been accessed and its page reference bit is set to one, then during replacement, such pages will be moved to the MRU end of T₂ (lines 29 and 36). In other words, CAR approximates ARC by performing a delayed and approximate MRU operation during cache replacement. As implemented, CAR is based on a non-demand-paging framework that uses a free buffer pool of pre-determined size. While cache hits are not serialized, like CLOCK, cache misses are still serialized behind a global lock to ensure correctness and consistency of the lists T₁, T₂, B₁, and B₂. This miss serialization can be somewhat mitigated by a free buffer pool. FIG. 4 illustrates the advantages of the CAR technique provided by the embodiments of the invention compared with the conventional techniques. As shown, CAR provides a solution for all aspects of caching, namely “recency”, “constant time”, “scan resistance”, “frequency”, and “lock contention/MRU overhead”, which are further described below.

A limitation of ARC is that two consecutive hits are used as a test to promote a page from “recency” or “short-term utility” to “frequency” or “long-term utility”. At an upper level of memory hierarchy, two or more successive references to the same page are often observed fairly quickly. Such quick successive hits are known as “correlated references” and are typically not a guarantee of long-term utility of pages, and, hence, such pages can cause cache pollution, thus reducing performance. As such, the embodiments of the invention solve this by providing a second embodiment of the invention, namely CLOCK with Adaptive Replacement and Temporal Filtering (CART). The motivation behind CART is to create a temporal filter that imposes a more stringent test for promotion from “short-term utility” to “long-term utility”. The basic idea is to maintain a temporal locality window such that pages that are re-requested within the window are of short-term utility, whereas pages that are re-requested outside the window are of long-term utility. Furthermore, the temporal locality window is itself an adaptable parameter of the methodology.

Generally, with regard to CART, the idea is to maintain four lists, namely, T₁, T₂, B₁, and B₂ as before. The pages in T₁ and T₂ are in the cache, whereas the pages in B₁ and B₂ are only in the cache history and are also maintained in a cache directory. However, the pages in B₁ and B₂ are in the cache directory, but are not in the cache. For simplicity, it is assumed that T₁ and T₂ are implemented as Second Chance lists, but in practice, they would be implemented as CLOCK lists. The following invariants on the sizes of the lists are applicable:

1) 0≦|T₁|+|T₂|≦c.

2) 0≦|T₂|+|B₂|≦c.

3) 0≦|T₁|+|B₁|≦2c.

4) 0≦|T₁|+|B₁|+|T₂|+|B₂|≦2c.

5) If |T₁|+|T₂|<c, then B₁∪B₂ is empty.

6) If |T₁|+|B₁|+|T₂|+|B₂|>c, then |T₁+|T₂|=c.

7) Due to demand paging, once the cache is full, it remains full from then on.

As for CAR and CLOCK, for each page in T₁∪T₂, a page reference bit is maintained. In addition, each page is marked with a filter bit to indicate whether it has long-term utility (say, “L”) or only short-term utility (say, “S”). No operation on this bit will be required during a cache hit. The symbol ‘x’ denotes a requested page. Here, the following rules apply:

1) Every page in T₂ and B₂ must be marked as “L”.

2) Every page in B₁ must be marked as “S”.

3) A page in T₁ could be marked as “S” or “L”.

4) A head page in T₁ can only be replaced if its page reference bit is set to 0 and its filter bit is set to “S”.

5) If the head page in T₁ is of type “L”, then it is moved to the tail position in T₂ and its page reference bit is set to zero.

6) If the head page in T₁ is of type “S” and has page reference bit set to 1, then it is moved to the tail position in T₁ and its page reference bit is set to zero.

7) A head page in T₂ can only be replaced if its page reference bit is set to 0.

8) If the head page in T₂ has page reference bit set to 1, then it is moved to the tail position in T₁ and its page reference bit is set to zero.

9) If x ∉T₁∪B₁∪T₂∪B₂, then set its type to “S.”

10) If x ∈T₁ and |T₁|≧|B₁|is empty, change its type to “L.”

11) If x ∈T₁ and B₁ then leave the type of x unchanged.

12) If x ∈T₂∪B₂, then x must be of type “S”, change its type to “L.”

13) If x ∈B₁, then x must be of type “S”, change its type to “L.”

When a page is removed from the cache directory; that is, from the set T₁∪B₁∪T₂∪B₂, its type is forgotten. In other words, a totally new page is put in T₁ and initially granted the status of “S”, and this status is not upgraded upon successive hits to the page in T₁, but only upgraded to “L” if the page is eventually demoted from the cache and a cache hit is observed to the page while it is in the history list B₁. This rule ensures that there are two references to the page that are temporally separated by at least the length of the list T₁. Hence, the length of the list T₁ is the temporal locality window. The policy ensures that the |T₁| pages in the list T₁ are the most recently used |T₁| pages.

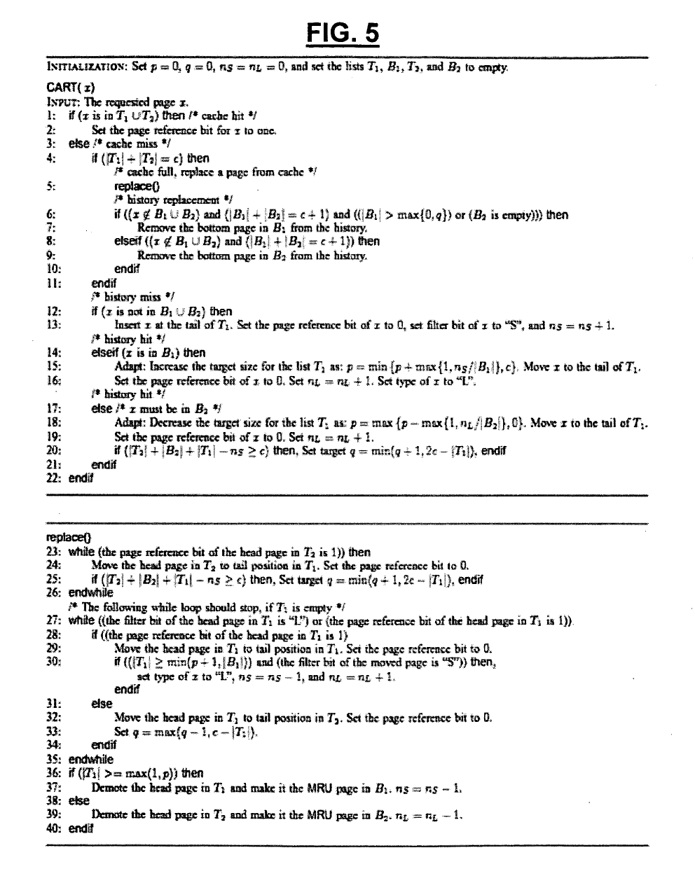

Generally, the CART methodology provides that the list T₁ contains exactly |T₁| least recently used pages (whether or type “S” or “L”) and the list T₂ contains remaining pages of type “L”. Thus, for CART, T₁ is a precise representation of “recency” and list T₂ contains pages of “long-term utility” that LRU would have not kept. The temporal locality window, namely, the size of the list T₁, is adapted in a workload-dependent, adaptive, online manner. The CART technique decides which list to delete (evict) from according to the rule in lines 36-40 of FIG. 5. A second parameter q is also maintained, which is the target size for the list B₁. The replacement rule for the cache history is described in lines 6-10 of FIG. 5.

Letting counters n_{S} and n_{L} denote the number of pages in the cache that have their filter bit set to “S” and “L”, respectively, it clearly follows that 0≦n_{S}+n_{L}≦c, and once the cache is full, n_{S}+n_{L}=c. With regard to the CART methodology of FIG. 5, line 1 checks whether there is a hit, and if so, then line 2 simply sets the page reference bit to one. There is no MRU operation akin to LRU or ARC involved. Hence, cache hits are not serialized behind a lock and virtually no overhead is involved. Moreover, the MRU operation is delayed until a replacement must be performed (lines 24 and 29).

Line 3 checks for a cache miss, and if so, then line 4 checks if the cache is full, and if so, then line 5 carries out the cache replacement by deleting (evicting) a page from either T₁ or T₂. The cache replacement policy “replace( )” in further described below. If there is a cache miss (line 3), then lines 6-10 examine whether a cache history has to be replaced. In particular, (line 6) if the requested page is totally new; that is, not in B₁ or B₂,|B₁|+B₂|=c+1, and B₁ exceeds its target, then (line 7) a page in B₁ is discarded, (line 8) else if the page is totally new and the cache history is completely full, then (line 9) a page in B₂ is discarded.

Finally, if there is a cache miss (line 3), then lines 12-21 carry out movements between the lists and also carry out the adaptation of the target size for T₁. In particular, (line 12) if the requested page is totally new, then (line 13) insert it at the tail of T₁, its page reference bit is set to zero, the filter bit is set to “S”, the counter n_{S} is incremented by 1. As indicated in line 14, else if the requested page is in B₁, then (line 15) the target size is increased for the list T₁ (increase the temporal window), and the requested page is inserted at the tail end of T₁ and (line 16) its page reference bit is set to zero, and, more importantly, its filter bit is changed to “L”. Finally, (line 17) if the requested page is in B₂, then (line 18) the target size is decreased for the list T₁ and the requested page is inserted at the tail end of T₁, (line 19) its page reference bit is set to zero, and (line 20) the target q is updated for the list B₁.

The essence of the adaptation rule is: on a hit in B₁, it favors increasing the size of T₁, and, on a hit in B₂, it favors decreasing the size of T₁. As indicated in lines 23-26, while the page reference bit of the head page in T₂ is 1, then the page is moved to the tail position in T₁, and the target q is updated to control the size of B₁. In other words, these lines capture the movement from T₂ to T₁. When this while loop terminates, either T₂ is empty, or the page reference bit of the head page in T₂ is set to 0, and, hence, can be removed from the cache if desired.

Next, as indicated in lines 27-35, while the filter bit of the head page in T₁ is “L” or the page reference bit of the head page in T₁ is 1, these pages are kept moving. When this while loop terminates, either T₁ will be empty, or the head page in T₁ has its filter bit set to “S” and the page reference bit is set to 0, and, hence, can be removed from the cache if desired. As provided in lines 28-30 of FIG. 5, if the page reference bit of the head page in T₁ is 1, then it is made the tail page in T₁. At the same time, if B₁ is very small or T₁ is larger than its target, then the temporal filtering constraint is relaxed, and the filter bit is set to “L”. Next, as shown in lines 31-33, ff the page reference bit is set to 0, but the filter bit is set to “L”, then the page is moved to the tail position in T₂. Also, the target B₁ is changed. Lines 36-40 represent the CART cache replacement policy. If T₁ contains at least p pages and is not empty, then the LRU page is removed in T₁, else the LRU page is removed in T₂.

The methodologies provided by the embodiments of the invention are validated by experimental analysis. In particular the several page caching techniques, namely, LRU, CLOCK, ARC, CAR (first embodiment), and CART (second embodiment) are compared. ARC has already been extensively compared to a wide variety of policies such as LRU-2, 2Q, MQ, LIRS, and LRFU, and has been shown to be comparable to these policies even when these policies where allowed to employ the best offline selection of their tunable parameters. Hence, ARC is a valid state-of-the-art policy to benchmark against. Finally, since CAR is an approximation to ARC, it of interest to know how much does this approximation cost in terms of performance

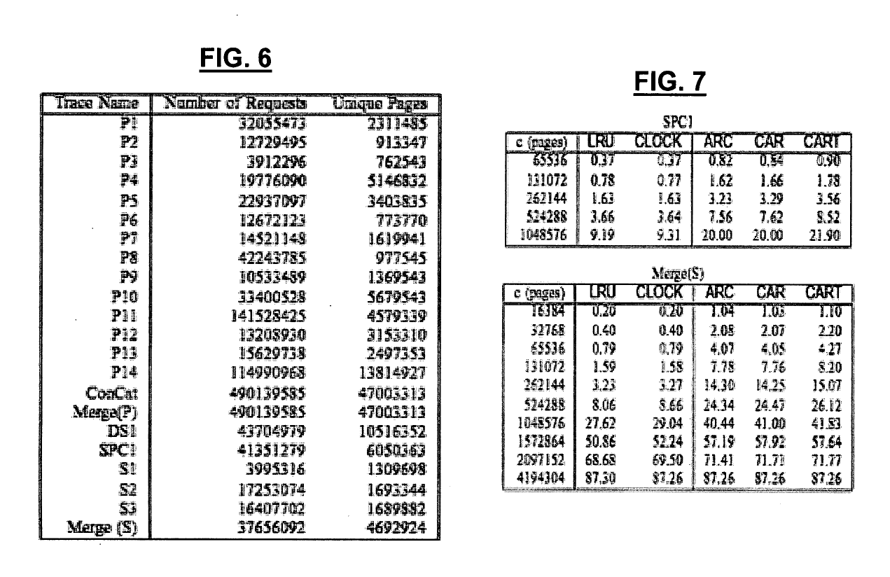

FIG. 6 summarizes various traces that are used for the purposes of the validation experiments. These traces capture disk accesses by databases, web servers, NT workstations, and a synthetic benchmark for storage controllers. All of the traces have been filtered by upstream caches, and, hence, are representative of workloads seen by storage controllers, disks, or RAID controllers. The traces P1-P14 were collected form workstations running Windows NT™ (available from Microsoft Corporation, Redmond, Wash., USA) by using Vtrace which captures disk operations through the use of device filters. The traces were gathered over several months. The page size for these traces was 512 bytes. The trace ConCat was obtained by concatenating the traces P1-P14. Similarly, the trace Merge(P) was obtained by merging the traces P1-P14 using time stamps on each of the requests. The idea is to synthesize a trace that may resemble a workload seen by a small storage controller.

The trace DS1 was taken off a database server running at a commercial site running an ERP application on top of a commercial database. The trace is seven days long. SPC1 is a synthetic benchmark trace that contains long sequential scans in addition to random accesses. The page size for this trace was 4 kB. Finally, the three traces S1, S2, and S3 were disk read accesses initiated by a large commercial search engine in response to various web search requests. The trace S1 was captured over a period of one hour, S2 was captured over approximately four hours, and S3 was captured over approximately six hours. The page size for these traces was 4 kB. The trace Merge(S) was obtained by merging the traces S1-S3 using time stamps on each of the requests. The trace Merge(S) is fairly large: 150 GB of requests and a footprint of 18 GB.

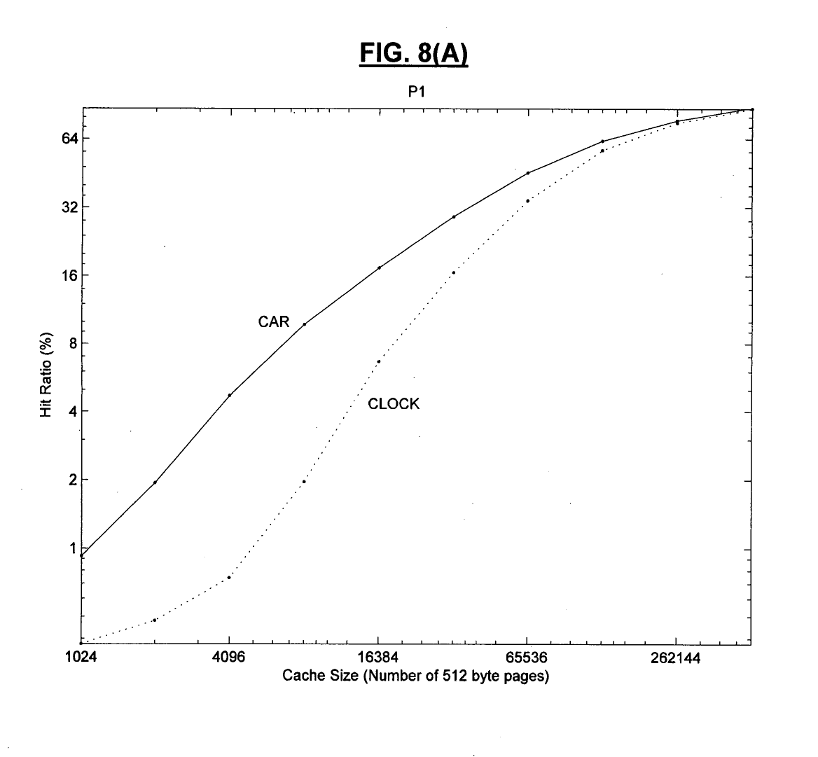

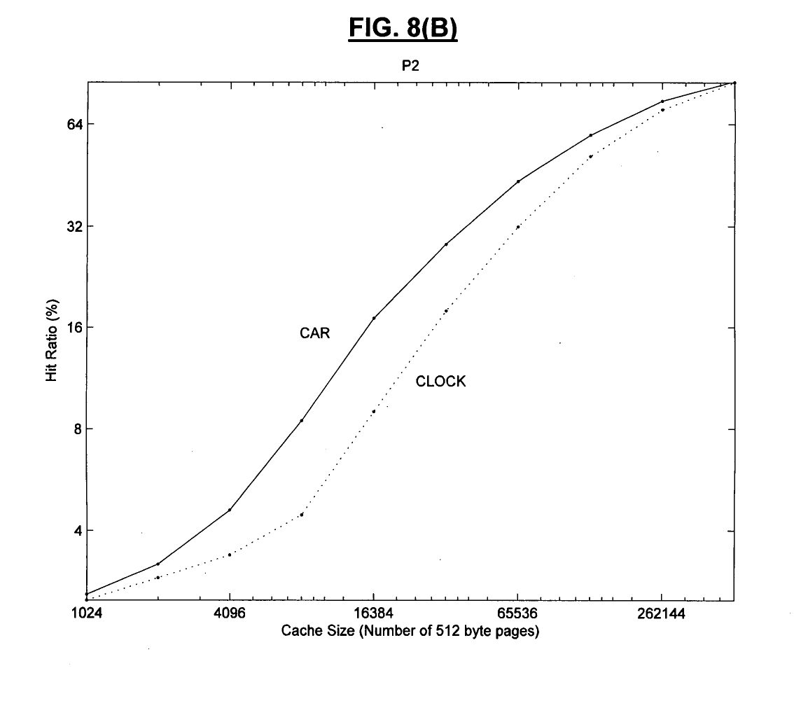

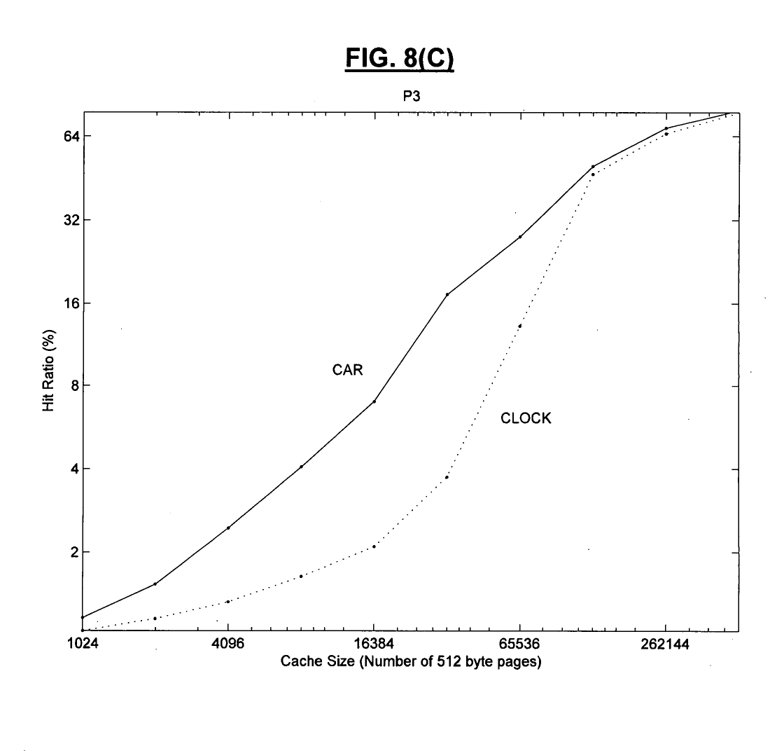

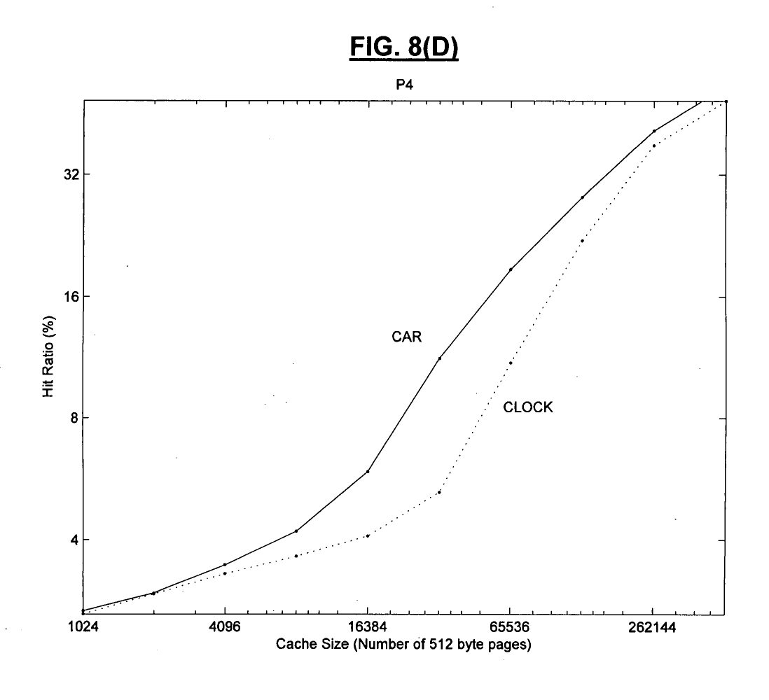

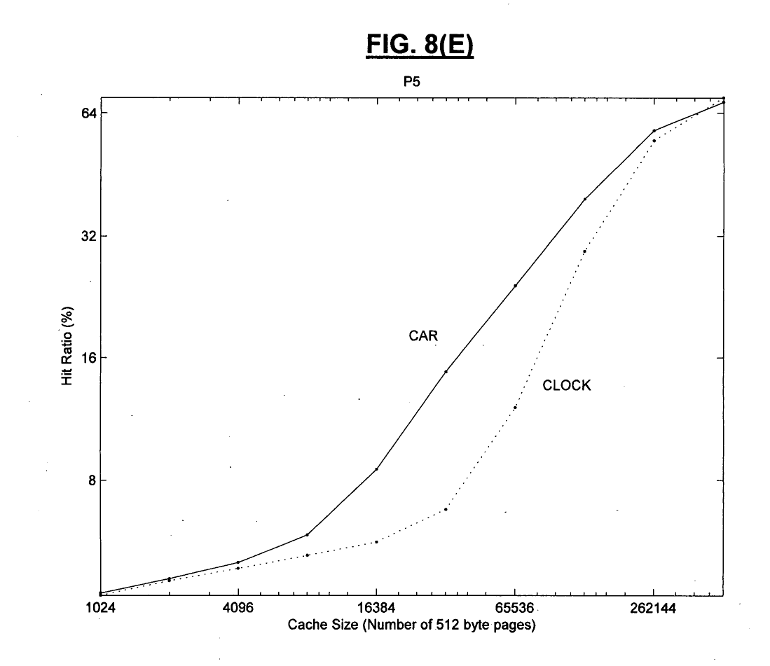

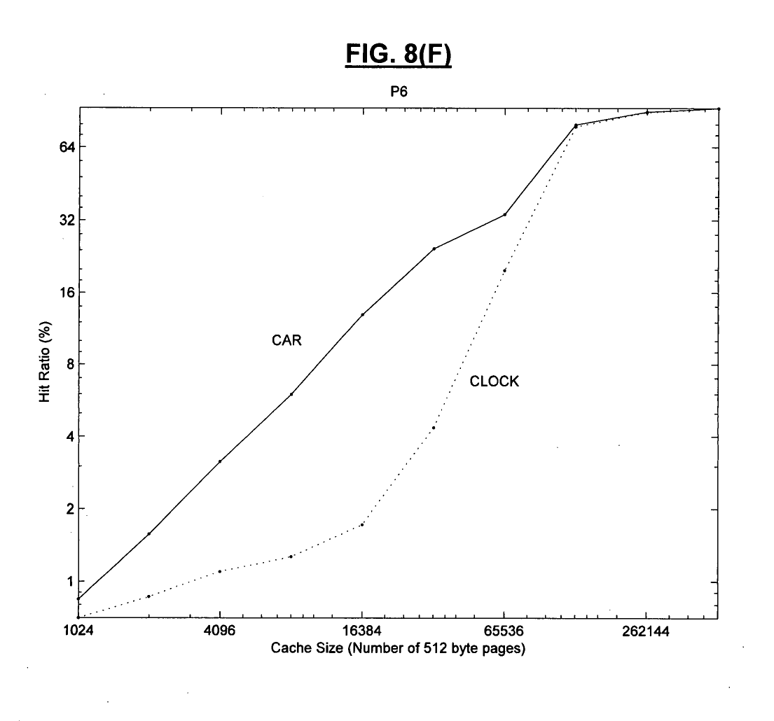

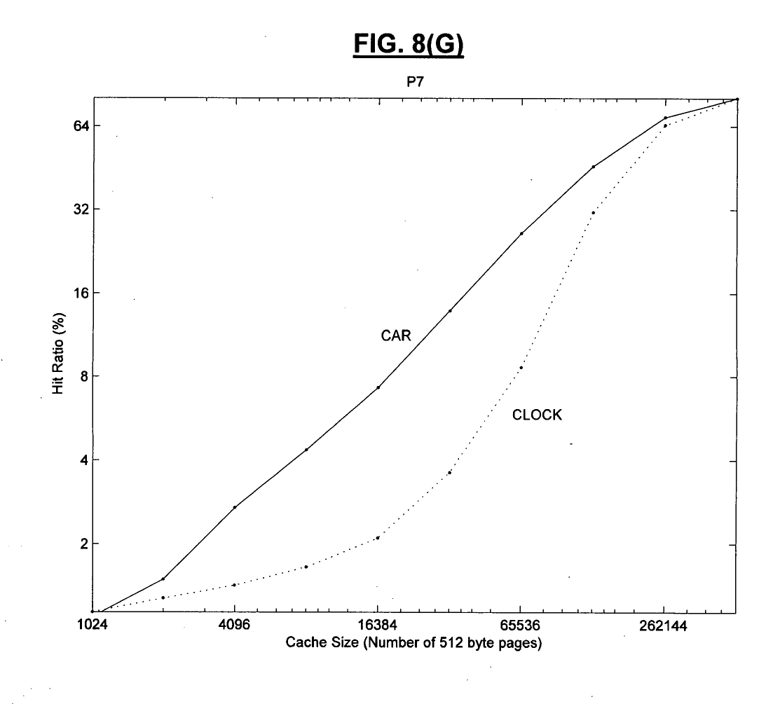

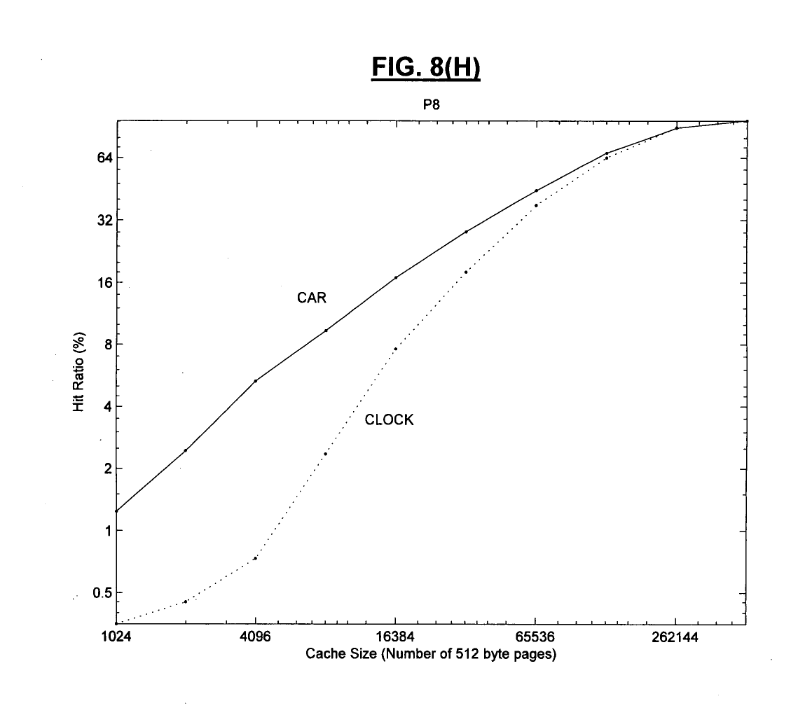

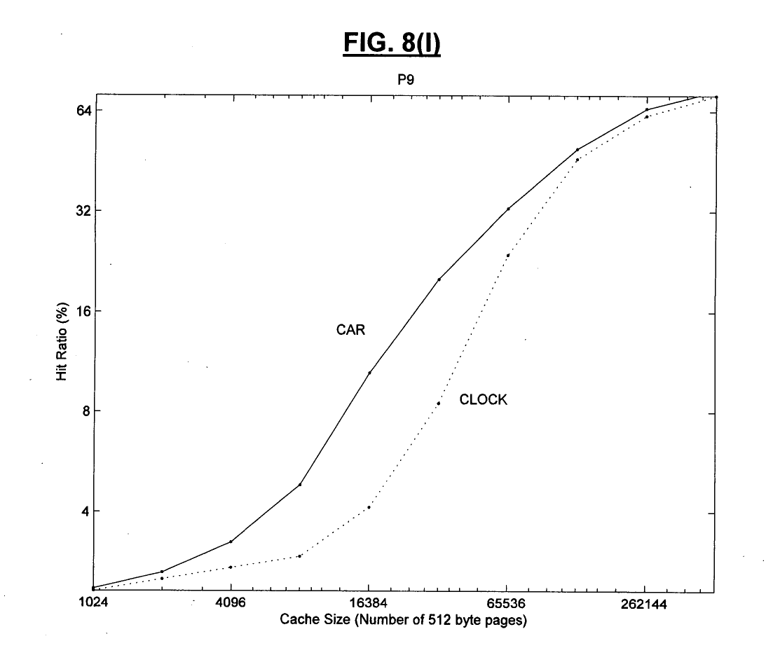

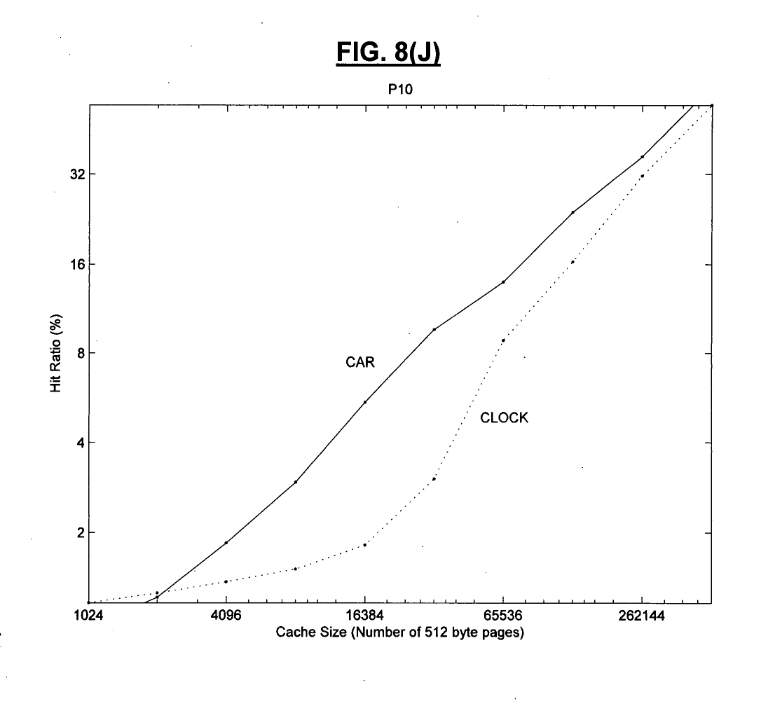

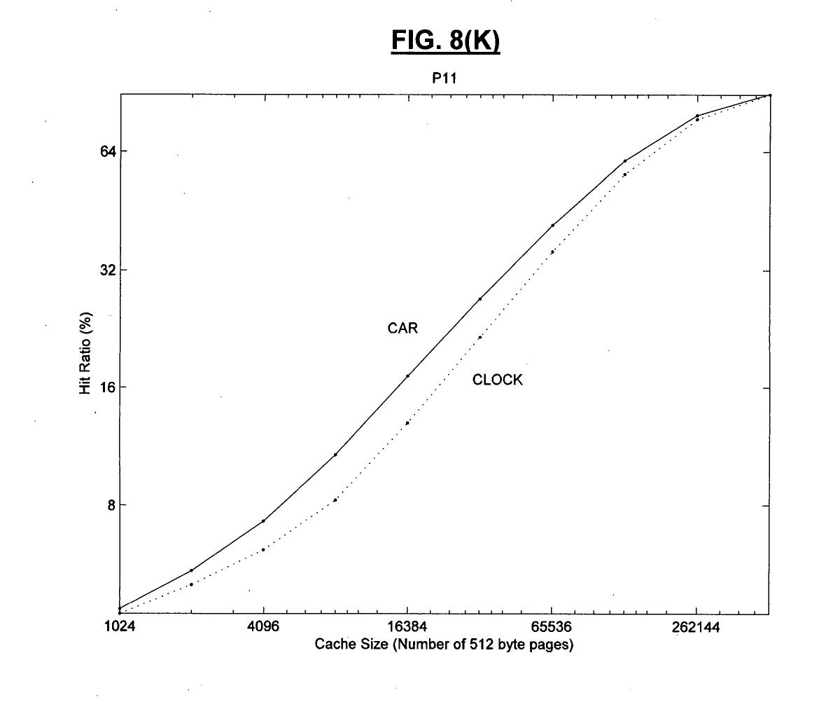

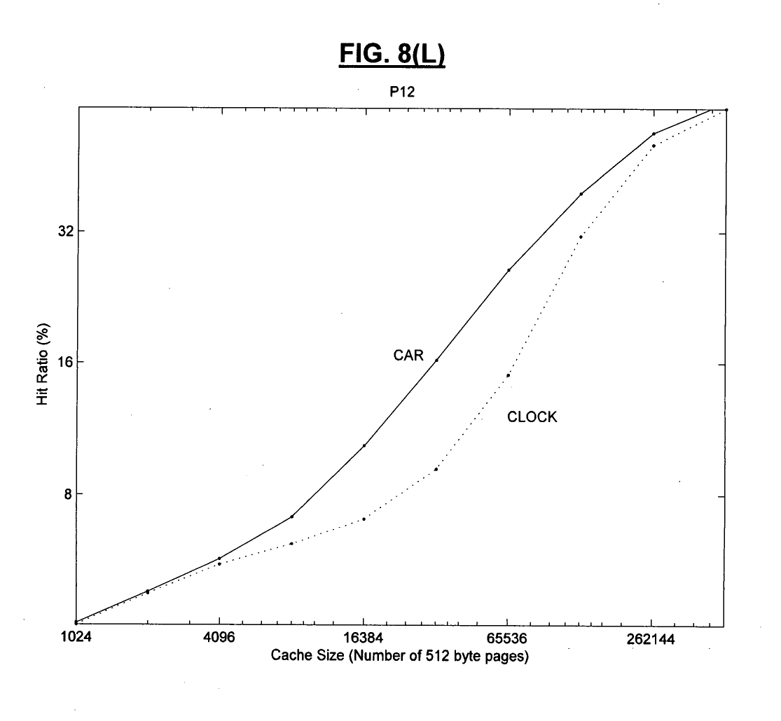

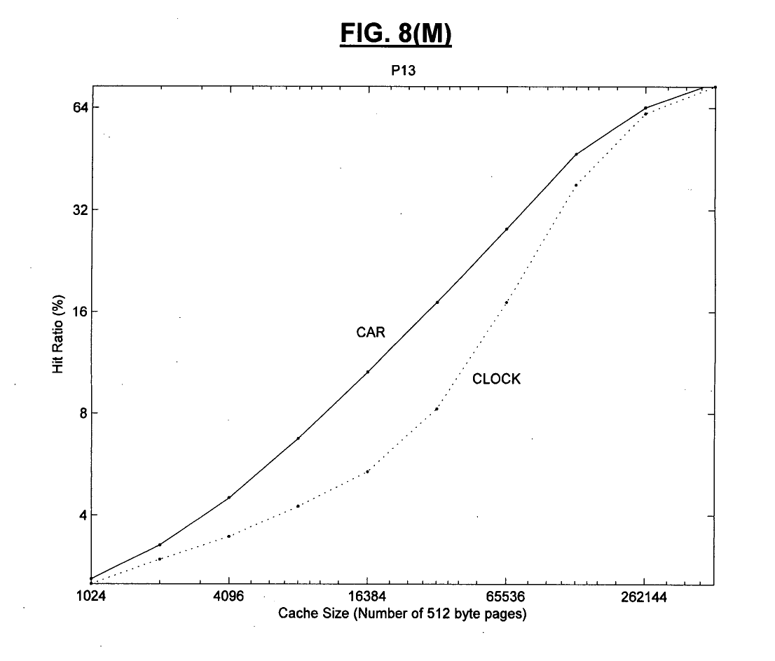

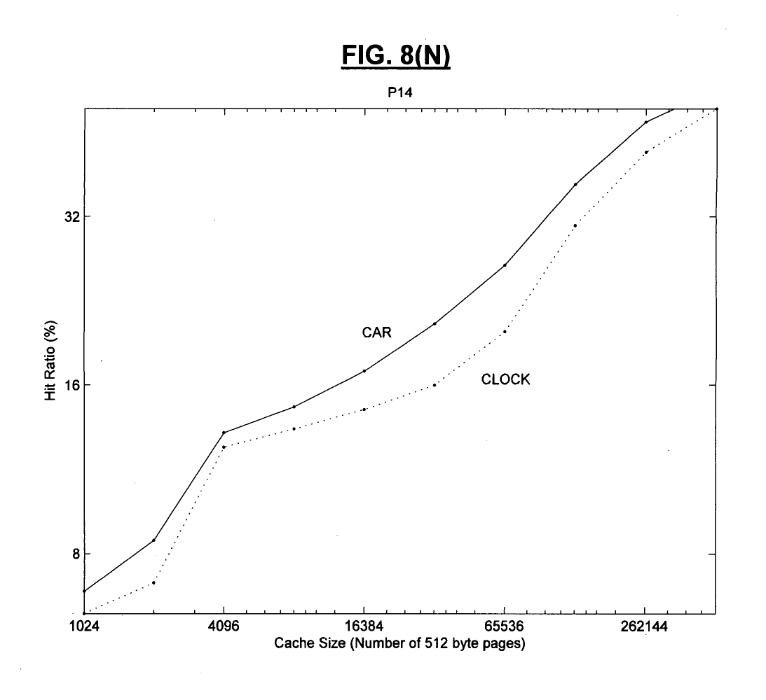

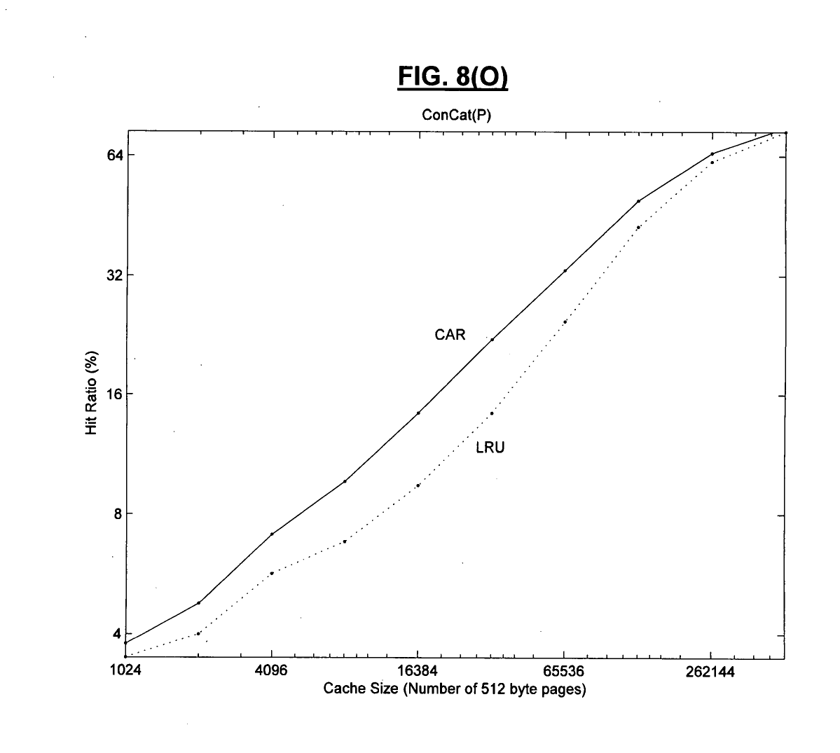

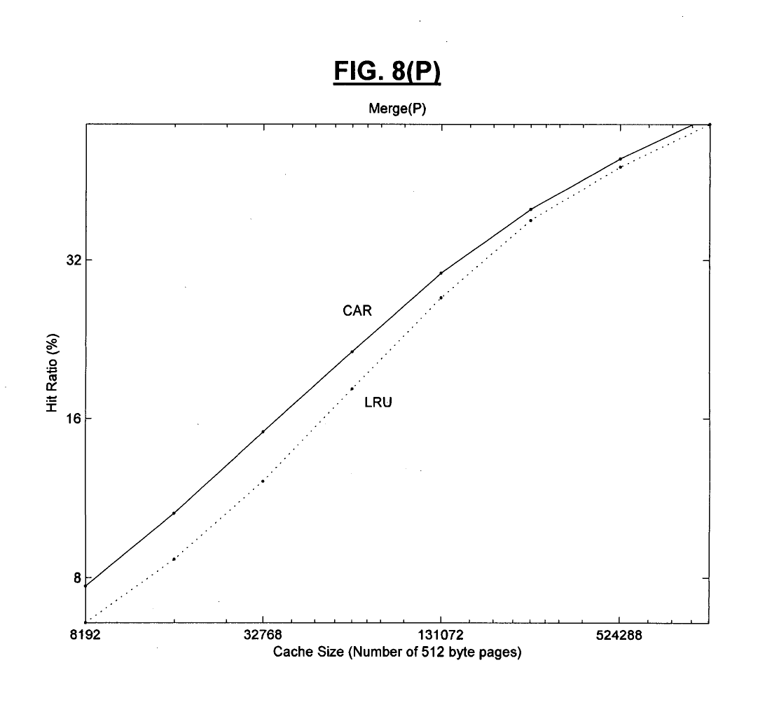

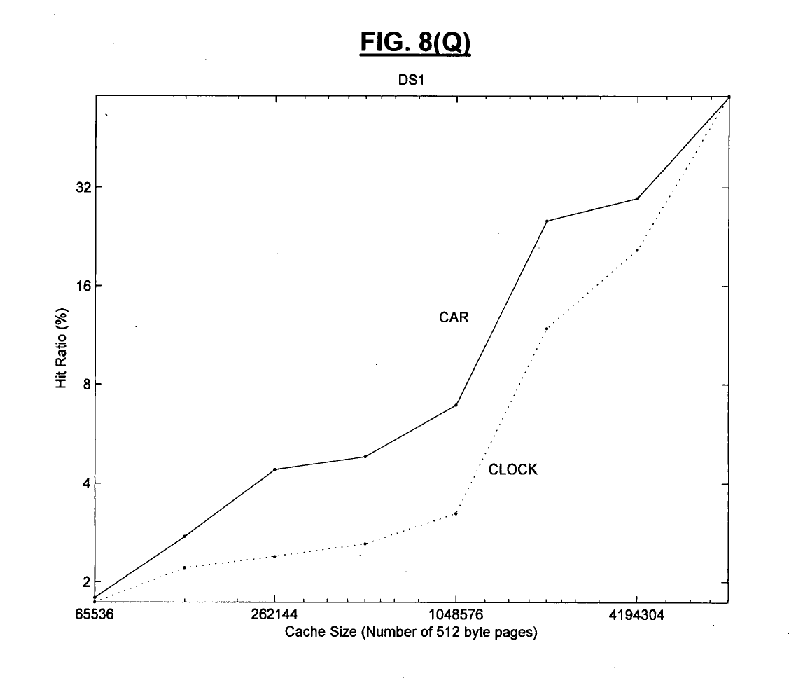

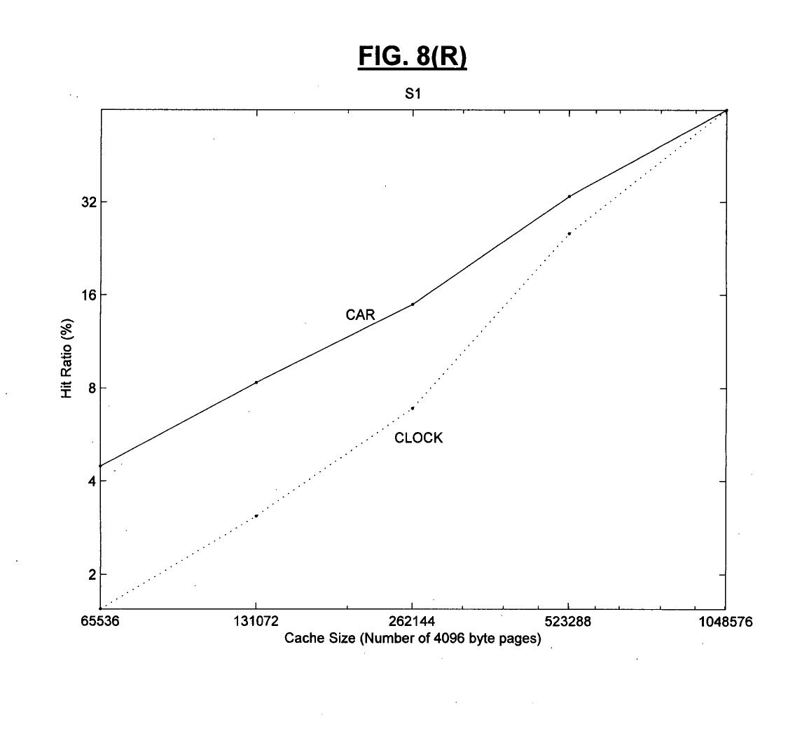

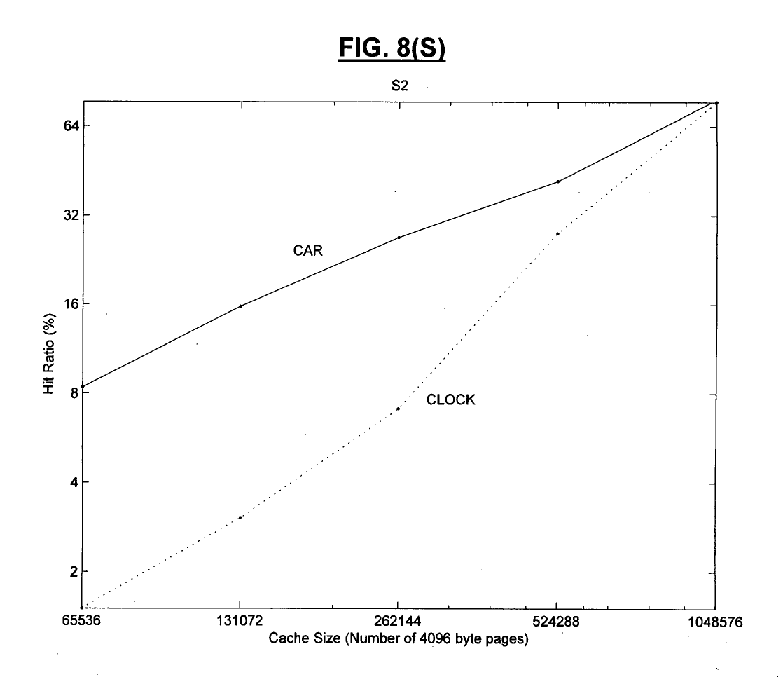

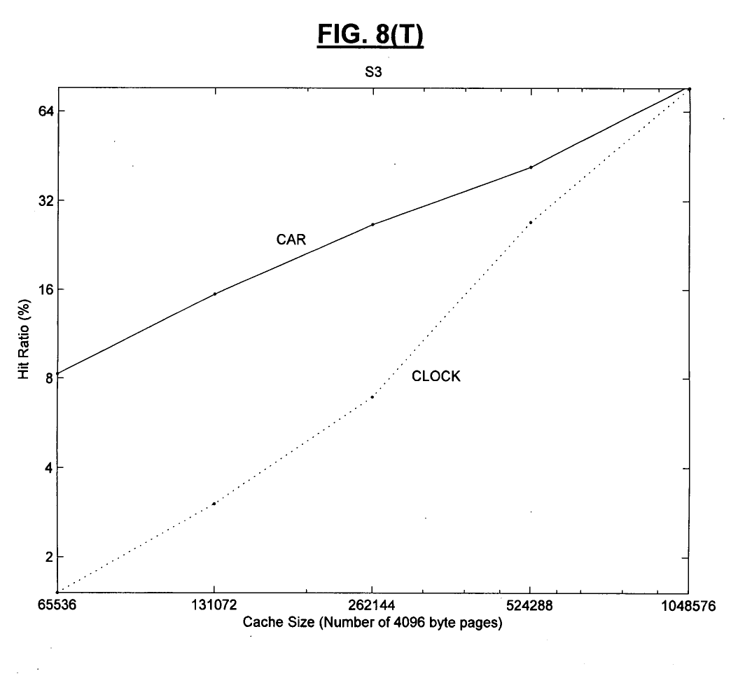

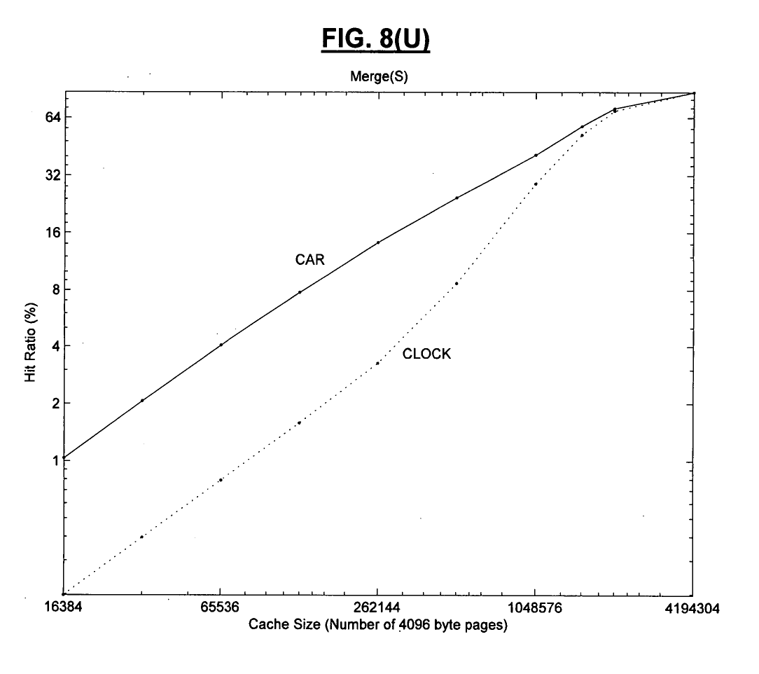

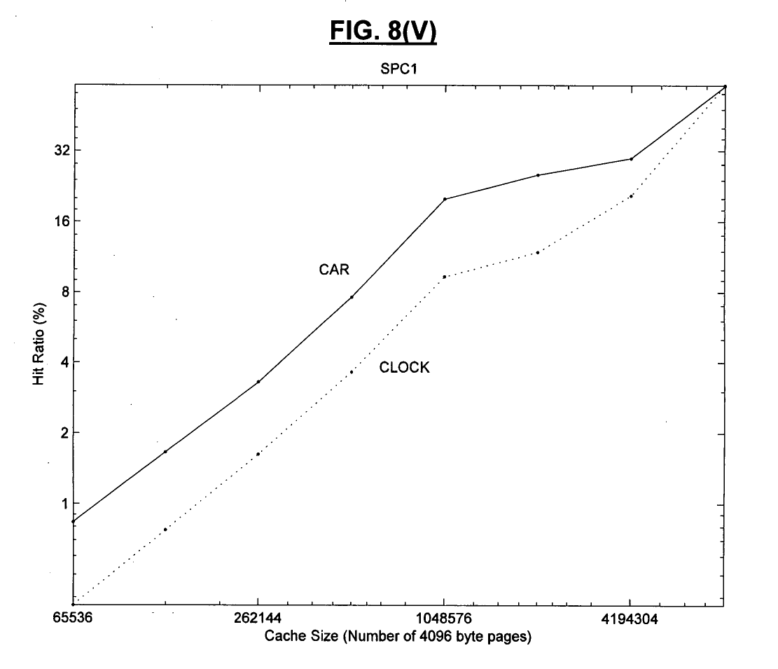

For all traces, only the read requests are considered. All hit ratios reported herein are cold start values, and are indicated as percentages (%). FIG. 7 compares LRU, CLOCK, ARC, CAR, and CART for the traces SPC1 and Merge(S) for various cache sizes. It can be clearly seen that CLOCK has performance characteristics very similar to LRU, and CAR/CART have performance characteristics very similar to ARC. Furthermore, CAR/CART substantially outperforms CLOCK. In FIGS. 8(A) through 8(V) (where both the x and y axes use a logarithmic scale), the hit-ratios of CAR are graphically compared to CLOCK for all of the traces P1-P14. As indicated in the plots, the performance of CAR was very close to ARC and CART and the performance of CLOCK was very similar to LRU, and, hence, to avoid clutter, LRU, ARC, and CART are not plotted. It can be clearly seen that across a wide variety of workloads and cache sizes, CAR outperforms CLOCK; sometimes quite dramatically.

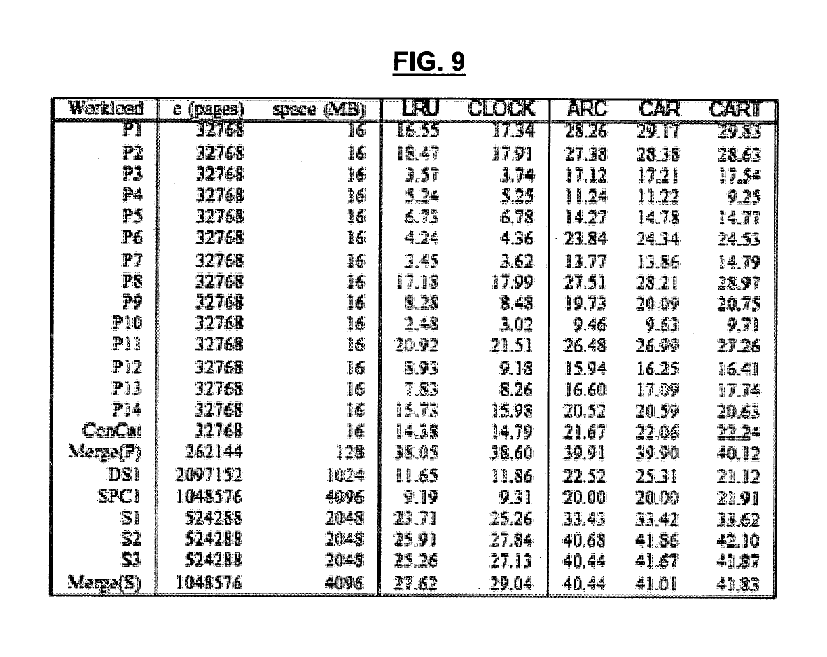

FIG. 9 illustrates a summary of the hit ratios for LRU, CLOCK, ARC, CAR, and CART for various traces and cache sizes. Once again, the same conclusions as above are seen to hold: ARC, CAR, and CART outperform LRU and CLOCK. Moreover, ARC, CAR, and CART have very similar performance characteristics, and CLOCK has performance characteristics very similar to LRU.

Generally, the embodiments of the invention combine ideas and features from CLOCK and ARC, which prior to the methodologies provided by the invention were impossible to functionally combine, thereby overcoming the disadvantages associated with the LRU technique. Specifically, CAR removes the cache hit serialization problem of LRU and ARC. This property follows since CAR (like CLOCK)) does not need to MRU a page on a cache hit. Furthermore, CAR has a very low overhead on cache hits. On a page hit, the only processing that is required is that the associated page reference bit is set to one. This operation can often be performed by the hardware, and, hence, is virtually free. Thus, CAR may be attractive in virtual memory, in high-performance databases, and large storage controllers.

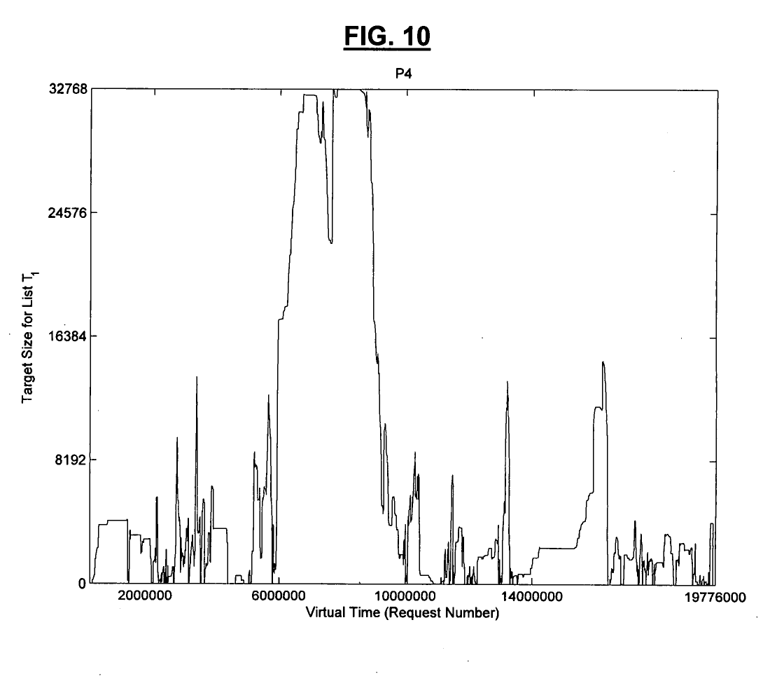

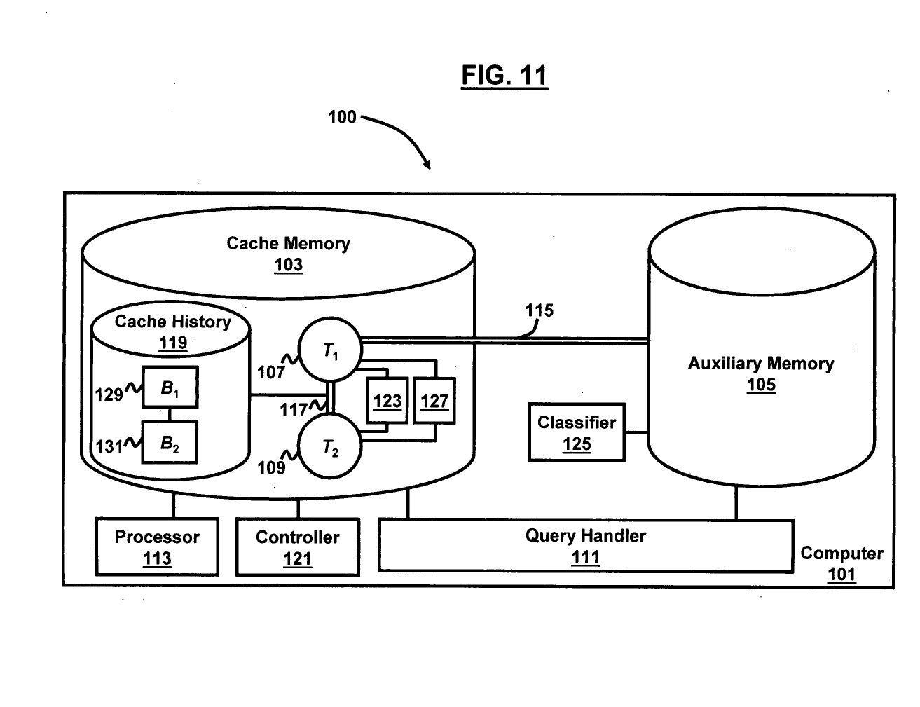

Additionally, CAR is self-tuning; that is, CAR requires only one tunable parameter p that balances between recency and frequency. The policy adaptively tunes this parameter in response to an evolving workload so as to increase the hit-ratio. A closer examination of the parameter p shows that it can fluctuate from recency (p=c) to frequency (p=0) and back, all within a single workload. In other words, adaptation is significant. Also, it can be shown that CAR performs as well as its offline counterpart, which is allowed to select the best, offline, fixed value of p chosen specifically for a given workload and a cache size. In other words, adaptation is significant. FIG. 10 graphically demonstrates how p fluctuates. Specifically, FIG. 10 is a plot of the adaptation parameter p (the target size for list T₁) versus the virtual time for the CAR methodology. The plot of FIG. 10 is for the trace P4 and the cache size of 32768 pages. The page size is 512 bytes for both traces. The self-tuning nature of CAR makes it very attractive for deployment in environments where no a priori knowledge of the workloads is available.

FIG. 11 illustrates a system 100 for adaptively managing data retrieval in a computer 101 according to an embodiment of the invention, wherein the system 100 comprises a cache memory 103 comprising a first clock list (T₁) 107 and a second clock list (T₂) 109, wherein the first clock list (T₁) 107 comprises pages with short-term utility and the second clock list 109 comprises pages with long-term utility. The system 100 further comprises a query handler 11 adapted to process requests for retrieval of a particular page in the computer 101; a processor 113 adapted to identify requested pages located in the cache memory 109 as a cache hit; a first data bus 115 adapted to transfer requested pages located in an auxiliary memory 105 of the system 100 to the first clock list (T₁) 107 of the cache memory 103; a second data bus 117 adapted to relocate the transferred requested pages into the second clock list (T₂) 109 upon achieving at least two consecutive cache hits of the transferred requested page; a cache history 119 comprising pages evicted from the cache memory 109; and a controller 121 adapted to vary a proportion of pages marked as the short-term utility and those marked as the long-term utility to increase a cache hit ratio of the cache memory 109 by utilizing the logged history of requested pages. The cache memory 103 is arranged into pages having uniformly-sized units of memory, and the query handler 111 is adapted to determine whether the particular page is located in the cache memory 103.

The system 100 further comprises a bit marker 123 comprising a page reference bit for each page in the cache memory 103, wherein a new page entering the cache memory 103 comprises a page reference bit of zero, and a page having a cache hit in the cache memory 103 comprises a page reference bit of one. Moreover, the system 100 further comprises a classifier 125 adapted to identify requested pages located in the auxiliary memory 105 as a cache miss, wherein upon identifying the cache miss, the system 100 further comprises a purger 127 adapted to delete (evict) a page in either the first clock list (T₁) 107 or the second clock list (T₂) 109 if the cache memory 103 is full. Furthermore, the cache history 119 comprises a first list of history pages (B₁) 129 and a second list of history pages (B₂) 131.

The embodiments of the invention achieve several advantages. For example, CAR is scan-resistant, wherein a scan is any sequence of one-time use requests. Such requests will be put on top of the list T₁ and will eventually exit from the cache without polluting the high-quality pages in T₂. Moreover, in presence of scans, there will be relatively fewer hits in B₁ as compared to B₂. Hence, the adaptation rule provided by the embodiments of the invention tend to further increase the size of T₂ at the expense of T₁, thus further decreasing the residency time of scan in even T₁.

Furthermore, CAR provides a high-performance methodology, as it outperforms LRU and CLOCK on a wide variety of traces and cache sizes, and has performance characteristics very comparable to ARC. Moreover, CAR has low space overhead, typically, less that 1% and is simple to implement, as is indicated by the methodology flow given in FIG. 3. Additionally, the CART methodology has all the above advantages of CAR, but, in addition, it employs a much stricter and more precise criterion to distinguish pages with short-term utility from those with long-term utility.

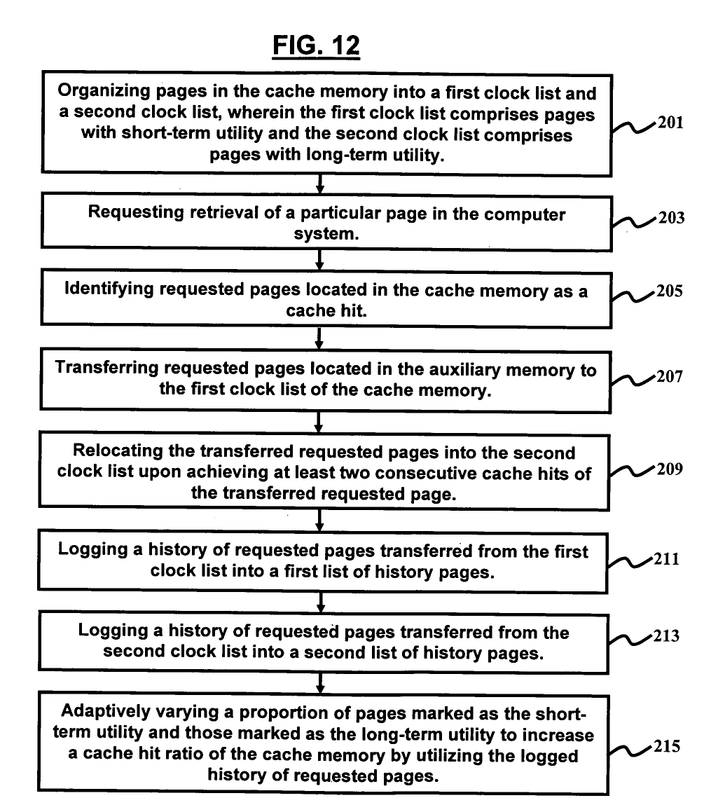

FIG. 12 illustrates the process flow according to an embodiment of the invention. FIG. 12 illustrates, with reference to FIG. 11, a method of managing data retrieval in a computer system 101 comprising a cache memory 103 and an auxiliary memory 105, wherein the method comprises organizing (201) pages in the cache memory 103 into a first clock list (T₁) 107 and a second clock list (T₂) 109, wherein the first clock list (T₁) 107 comprises pages with short-term utility and the second clock list (T₂) 109 comprises pages with long-term utility; requesting (203) retrieval of a particular page in the computer system 101; identifying (205) requested pages located in the cache memory 103 as a cache hit; transferring (207) requested pages located in the auxiliary memory 105 to the first clock list (T₁) 107 of the cache memory 103; relocating (209) the transferred requested pages into the second clock list (T₂) 109 upon achieving at least two consecutive cache hits of the transferred requested page; logging (211) a history of pages evicted from the first clock list (T₁) into a first list of history pages (B₁) 129; logging (213) a history of pages evicted from the second clock list (T₂) into a second list of history pages (B₂) 131; and adaptively varying (215) a proportion of pages marked as the short-term utility and those marked as the long-term utility to increase a cache hit ratio of the cache memory 103 by utilizing the logged history of evicted pages, wherein the cache memory 103 is arranged into pages having uniformly-sized units of memory, and wherein the process of requesting (203) access to a particular page in the computer system 101 comprises determining whether the particular page is located in the cache memory 103.

The method further comprises maintaining a page reference bit for each page in the cache memory 103, wherein a new page entering the cache memory 103 comprises a page reference bit of zero, and a page having a cache hit in the cache memory 103 comprises a page reference bit of one. The method further comprises identifying requested pages located in the auxiliary memory 105 and not in the cache memory 103 as a cache miss, wherein upon identifying the cache miss, the method further comprises deleting (evicting) a page in either the first clock list (T₁) 107 or the second clock list (T₂) 109 if the cache memory 103 is full. Moreover, the method further comprises logging the history of evicted pages into a cache history 119 of the cache memory 103, wherein the cache history 119 comprises the first list of history pages (B₁) 129 and the second list of history pages (B₂) 131.

The method further comprises determining whether the requested pages are located in either of the first list of history pages (B₁) 129 or the second list of history pages (B₂) 131; determining whether the cache history 119 is full; deleting (evicting) a page in the first list of history pages (B₁) 129 if the transferred requested pages are not located in either of the first list of history pages (B₁) 129 or the second list of history pages (B₂) 131 and the cache history 103 is full and a size of the first list of history pages (B₁) 129 plus a size of the first clock list (T₁) 107 is equal to a total number of pages in the cache memory 103; and deleting (evicting) a page in the second list of history pages (B₂) 131 if the transferred requested pages are not located in either of the first list of history pages (B₁) 129 or the second list of history pages (B₂) 131 and the cache history 119 is full and a size of the first list of history pages (B₁) 129 plus a size of the first clock list (T₁) 107 is less than a total number of pages in the cache memory 103.

Alternatively, the method further comprises identifying requested pages located in the auxiliary memory 105 as a cache miss; inserting a transferred requested page at a MRU position in the first clock list (T₁) 107; and setting the page reference bit of the transferred requested page to zero. Still alternatively, the method further comprises logging the history of evicted pages into a cache history 119 of the cache memory 103; determining whether the requested pages are located in the first list of history pages (B₁) 129; establishing a target size p of the first clock list (T₁) 107; increasing the target size p of the first clock list (T₁) 107 upon a determination that the requested pages are located in the first list of history pages (B₁) 129; inserting a transferred requested page at a MRU page position in the second clock list (T₂) 109 upon a determination that the requested page is located in the first list of history pages (B₁) 129; and setting the page reference bit of the transferred requested page to zero.

In another alternate embodiment, the method further comprises determining whether the requested pages are located in the second list of history pages (B₂) 131; establishing a target size p of the first clock list (T₁) 107; decreasing the target size p of the first clock list (T₁) 107 upon a determination that the requested pages are located in the second list of history pages (B₂) 131; inserting a transferred requested page at a MRU page position in the second clock list (T₂) 109 upon a determination that the requested page is located in the second list of history pages (B₂) 131; and setting the page reference bit of the transferred requested page to zero.

In yet another alternative embodiment, the method further comprises identifying a LRU page of the first clock list (T₁) 107; evicting the LRU page from the first clock list (T₁) 107; transferring the LRU page to a MRU page position in the first list of history pages (B₁) 129 if the page reference bit of the LRU page is zero and a size of the first clock list (T₁) 107 is at least as large as a predetermined target size p.

Still alternatively, the method further comprises transferring the LRU page from the first clock list (T₁) 107 to a MRU page position in the second clock list (T₂) 109 if the page reference bit of the LRU page is one. In another alternative embodiment, the method further comprises identifying a LRU page of the second clock list (T₂) 109; evicting the LRU page from the second clock list (T₂) 109; transferring the LRU page to a MRU page position in the second list of history pages (B₂) 131 if the page reference bit of the LRU page is zero and a size of the first clock list (T₁) 107 is smaller than a predetermined target size p. In another additional alternative embodiment, the method further comprises transferring the LRU page from the second clock list (T₂) 109 to a MRU page position in the second clock list (T₂) 109 if the page reference bit of the LRU page is one.

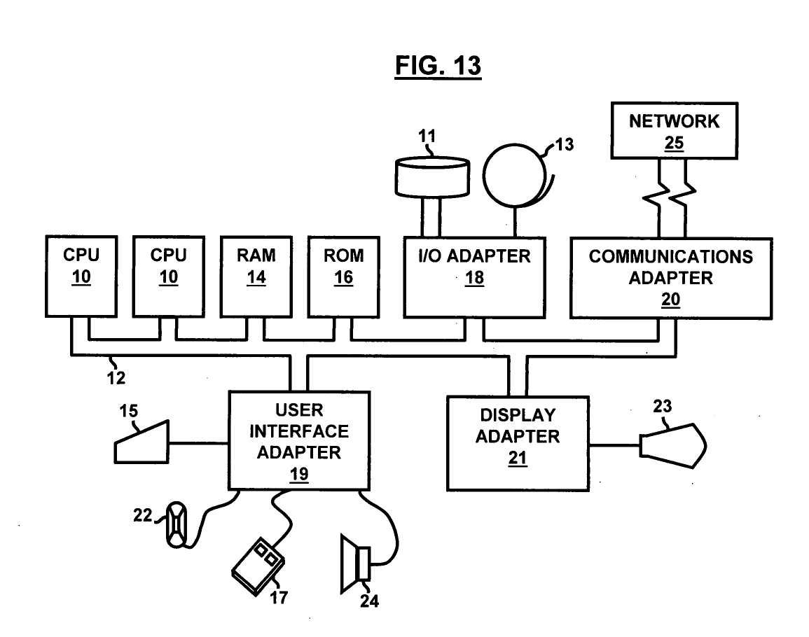

A representative hardware environment for practicing the embodiments of the invention is depicted in FIG. 13. This schematic drawing illustrates a hardware configuration of an information handling/computer system in accordance with the embodiments of the invention. The system comprises at least one processor or central processing unit (CPU) 10. The CPUs 10 are interconnected via system bus 12 to various devices such as a random access memory (RAM) 14, read-only memory (ROM) 16, and an input/output (I/O) adapter 18. The I/O adapter 18 can connect to peripheral devices, such as disk units 11 and tape drives 13, or other program storage devices that are readable by the system. The system can read the inventive instructions on the program storage devices and follow these instructions to execute the methodology of the embodiments of the invention. The system further includes a user interface adapter 19 that connects a keyboard 15, mouse 17, speaker 24, microphone 22, and/or other user interface devices such as a touch screen device (not shown) to the bus 12 to gather user input. Additionally, a communication adapter 20 connects the bus 12 to a data processing network 25, and a display adapter 21 connects the bus 12 to a display device 23 which may be embodied as an output device such as a monitor, printer, or transmitter, for example.

Generally, the embodiments of the invention provide a caching technique called CLOCK with Adaptive Replacement (CAR), which removes all of the disadvantages associated with the conventional LRU technique. Generally, the inventive CAR technique provided by the embodiments of the invention maintain two clock lists, for example, T₁ and T₂, where T₁ contains pages with “recency” or “short-term utility” and T₂ contains pages with “frequency” or “long-term utility”. New pages are first inserted in T₁ and graduate to T₂ upon passing a certain test of long-term utility. By using a certain precise history mechanism that remembers recently evicted pages from T₁ and T₂, the embodiments of the invention adaptively determines the sizes of these lists in a data-driven fashion. Using extensive trace-driven simulations, the effectiveness of the methodology provided by the embodiments of the invention is illustrated. Moreover, the trace-driven simulations demonstrate that CAR has performance characteristics comparable to ARC, and substantially outperforms both LRU and CLOCK. Furthermore, like ARC, the CAR methodology is self-tuning and requires no user-specified parameters.

The CAR methodology considers two consecutive hits to a page as a test of its long-term utility. At upper levels of memory hierarchy, for example, virtual memory, databases, and file systems, two or more successive references to the same page are observed fairly quickly. Furthermore, the embodiments of the invention provide a second page caching technique called CAR with Temporal filtering (CART), which has all of the advantages of CAR, but, imposes a more stringent test to demarcate between pages with long-term utility from those with only short-term utility. The CAR technique may be more suitable for disk, RAID, and storage controllers, whereas the CART technique may be more suited to virtual memory, databases, and file systems.

The foregoing description of the specific embodiments will so fully reveal the general nature of the invention that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the invention has been described in terms of preferred embodiments, those skilled in the art will recognize that the invention can be practiced with modification within the spirit and scope of the appended claims.

What is claimed is:

1. A method of managing data retrieval in a computer system comprising a cache memory and an auxiliary memory, said method comprising:
organizing pages in said cache memory into a first clock list and a second clock list, wherein said first clock list comprises pages with short-term utility and said second clock list comprises pages with long-term utility;
requesting retrieval of a particular page in said computer system;
identifying requested pages located in said cache memory as a cache hit;
transferring requested pages located in said auxiliary memory to said first clock list of said cache memory;
relocating the transferred requested pages into said second clock list upon achieving at least two consecutive cache hits of said transferred requested page;
logging a history of pages evicted from said cache memory; and
adaptively varying a proportion of pages marked as said short-term utility and those marked as said long-term utility to increase a cache hit ratio of said cache memory by utilizing the logged history of evicted pages.

2. The method of claim 1, wherein said cache memory is arranged into pages having uniformly-sized units of memory.

3. The method of claim 1, wherein said requesting access to a particular page in said computer system comprises determining whether said particular page is located in said cache memory.

4. The method of claim 1, further comprising maintaining a page reference bit for each page in said cache memory, wherein a new page entering said cache memory comprises a page reference bit of zero, and a page having a cache hit in said cache memory comprises a page reference bit of one.

5. The method of claim 1, further comprising identifying requested pages located in said auxiliary memory and not in said cache memory as a cache miss.

6. The method of claim 5, wherein upon identifying said cache miss, said method further comprises evicting a page in either said first clock list or said second clock list if said cache memory is full.

7. The method of claim 6, further comprising logging said history of evicted pages into a cache history of said cache memory, wherein said cache history comprises a first list of history pages comprising pages evicted from said first clock list; and a second list of history pages comprising pages evicted from said second clock list.

8. The method of claim 7, further comprising:
determining whether said requested pages are located in either of said first list of history pages or said second list of history pages;
determining whether said cache history is full;
evicting a page in said first list of history pages if said transferred requested pages are not located in either of said first list of history pages or said second list of history pages and said cache history is full and a size of said first list of history pages plus a size of said first clock list is equal to a total number of pages in said cache memory; and
evicting a page in said second list of history pages if said transferred requested pages are not located in either of said first list of history pages or said second list of history pages and said cache history is full and a size of said first list of history pages plus a size of said first clock list is less than a total number of pages in said cache memory.

9. The method of claim 4, further comprising:
identifying requested pages located in said auxiliary memory as a cache miss;
inserting a transferred requested page at a most recently used (MRU) position in said first clock list; and
setting said page reference bit of said transferred requested page to zero.

10. The method of claim 4, further comprising:
logging said history of evicted pages into a cache history of said cache memory, wherein said cache history comprises a first list of history pages and a second list of history pages;
determining whether said requested pages are located in said first list of history pages;
establishing a target size of said first clock list;
increasing said target size of said first clock list upon a determination that said requested pages are located in said first list of history pages;
inserting a transferred requested page at a most recently used (MRU) page position in said second clock list upon a determination that said requested page is located in said first list of history pages; and
setting said page reference bit of said transferred requested page to zero.

11. The method of claim 4, further comprising:
logging said history of evicted pages into a cache history of said cache memory, wherein said cache history comprises a first list of history pages and a second list of history pages;
determining whether said requested pages are located in said second list of history pages;
establishing a target size of said first clock list;
decreasing said target size of said first clock list upon a determination that said requested pages are located in said second list of history pages;
inserting a transferred requested page at a most recently used (MRU) page position in said second clock list upon a determination that said requested page is located in said second list of history pages; and
setting said page reference bit of said transferred requested page to zero.

12. The method of claim 4, further comprising:
logging said history of evicted pages into a cache history of said cache memory, wherein said cache history comprises a first list of history pages and a second list of history pages;
identifying a least recently used (LRU) page of said first clock list;
evicting said LRU page from said first clock list; and
transferring said LRU page to a most recently used (MRU) page position in said first list of history pages if said page reference bit of said LRU page is zero and a size of said first clock list is at least as large as a predetermined target size.

13. The method of claim 4, further comprising:
identifying a least recently used (LRU) page of said first clock list;
transferring said LRU page from said first clock list to a most recently used (MRU) page position in said second clock list if said page reference bit of said LRU page is one; and
resetting said page reference bit to zero.

14. The method of claim 4, further comprising:
logging said history of evicted pages into a cache history of said cache memory, wherein said cache history comprises a first list of history pages and a second list of history pages;
identifying a least recently used (LRU) page of said second clock list;
evicting said LRU page from said second clock list; and
transferring said LRU page to a most recently used (MRU) page position in said second list of history pages if said page reference bit of said LRU page is zero and a size of said first clock list is smaller than a predetermined target size.

15. The method of claim 4, further comprising:
identifying a least recently used (LRU) page of said second clock list; and
transferring said LRU page from said second clock list to a most recently used (MRU) page position in said second clock list if said page reference bit of said LRU page is one.

16. A program storage device readable by computer, tangibly embodying a program of instructions executable by said computer to perform a method of managing data retrieval in a computer system comprising a cache memory and an auxiliary memory, said method comprising:
organizing pages in said cache memory into a first clock list and a second clock list, wherein said first clock list comprises pages with short-term utility and said second clock list comprises pages with long-term utility;
requesting retrieval of a particular page in said computer system;
identifying requested pages located in said cache memory as a cache hit;
transferring requested pages located in said auxiliary memory to said first clock list of said cache memory;
relocating the transferred requested pages into said second clock list upon achieving at least two consecutive cache hits of said transferred requested page;
logging a history of pages evicted from said cache memory; and
adaptively varying a proportion of pages marked as said short-term utility and those marked as said long-term utility to increase a cache hit ratio of said cache memory by utilizing the logged history of evicted pages.

17. The program storage device of claim 16, wherein said cache memory is arranged into pages having uniformly-sized units of memory.

18. The program storage device of claim 16, wherein said requesting access to a particular page in said computer system comprises determining whether said particular page is located in said cache memory.

19. The program storage device of claim 16, wherein said method further comprises maintaining a page reference bit for each page in said cache memory, wherein a new page entering said cache memory comprises a page reference bit of zero, and a page having a cache hit in said cache memory comprises a page reference bit of one.

20. The program storage device of claim 16, wherein said method further comprises identifying requested pages located in said auxiliary memory and not in said cache memory as a cache miss.

21. The program storage device of claim 20, wherein upon identifying said cache miss, said method further comprises evicting a page in either said first clock list or said second clock list if said cache memory is full.

22. The program storage device of claim 21, wherein said method further comprises logging said history of evicted pages into a cache history of said cache memory, wherein said cache history comprises a first list of history pages comprising pages evicted from said first clock list; and a second list of history pages comprising pages evicted from said second clock list.

23. The program storage device of claim 22, wherein said method further comprises:
determining whether said requested pages are located in either of said first list of history pages or said second list of history pages;
determining whether said cache history is full;
evicting a page in said first list of history pages if said transferred requested pages are not located in either of said first list of history pages or said second list of history pages and said cache history is full and a size of said first list of history pages plus a size of said first clock list is equal to a total number of pages in said cache memory; and
evicting a page in said second list of history pages if said transferred requested pages are not located in either of said first list of history pages or said second list of history pages and said cache history is full and a size of said first list of history pages plus a size of said first clock list is less than a total number of pages in said cache memory.

24. The program storage device of claim 19, wherein said method further comprises:
identifying requested pages located in said auxiliary memory as a cache miss;
inserting a transferred requested page at a most recently used (MRU) position in said first clock list; and
setting said page reference bit of said transferred requested page to zero.

25. The program storage device of claim 19, wherein said method further comprises:
logging said history of evicted pages into a cache history of said cache memory, wherein said cache history comprises a first list of history pages and a second list of history pages;
determining whether said requested pages are located in said first list of history pages;
establishing a target size of said first clock list;
increasing said target size of said first clock list upon a determination that said requested pages are located in said first list of history pages;
inserting a transferred requested page at a most recently used (MRU) page position in said second clock list upon a determination that said requested page is located in said first list of history pages; and
setting said page reference bit of said transferred requested page to zero.

26. The program storage device of claim 19, wherein said method further comprises:
logging said history of evicted pages into a cache history of said cache memory, wherein said cache history comprises a first list of history pages and a second list of history pages;
determining whether said requested pages are located in said second list of history pages;
establishing a target size of said first clock list;
decreasing said target size of said first clock list upon a determination that said requested pages are located in said second list of history pages;
inserting a transferred requested page at a most recently used (MRU) page position in said second clock list upon a determination that said requested page is located in said second list of history pages; and
setting said page reference bit of said transferred requested page to zero.

27. The program storage device of claim 19, wherein said method further comprises:
logging said history of evicted pages into a cache history of said cache memory, wherein said cache history comprises a first list of history pages and a second list of history pages;
identifying a least recently used (LRU) page of said first clock list;
evicting said LRU page from said first clock list; and
transferring said LRU page to a most recently used (MRU) page position in said first list of history pages if said page reference bit of said LRU page is zero and a size of said first clock list is at least as large as a predetermined target size.

28. The program storage device of claim 19, wherein said method further comprises:
identifying a least recently used (LRU) page of said first clock list;
transferring said LRU page from said first clock list to a most recently used (MRU) page position in said second clock list if said page reference bit of said LRU page is one; and
resetting said page reference bit to zero.

29. The program storage device of claim 19, wherein said method further comprises:
logging said history of evicted pages into a cache history of said cache memory, wherein said cache history comprises a first list of history pages and a second list of history pages;
identifying a least recently used (LRU) page of said second clock list;
evicting said LRU page from said second clock list; and
transferring said LRU page to a most recently used (MRU) page position in said second list of history pages if said page reference bit of said LRU page is zero and a size of said first clock list is smaller than a predetermined target size.

30. The program storage device of claim 19, wherein said method further comprises:
identifying a least recently used (LRU) page of said second clock list; and
transferring said LRU page from said second clock list to a most recently used (MRU) page position in said second clock list if said page reference bit of said LRU page is one.

31. A system for adaptively managing data retrieval in a computer, said system comprising:
a cache memory comprising a first clock list and a second clock list, wherein said first clock list comprises pages with short-term utility and said second clock list comprises pages with long-term utility;
a query handler adapted to process requests for retrieval of a particular page in said computer;
a processor adapted to identify requested pages located in said cache memory as a cache hit;
a first data bus adapted to transfer requested pages located in an auxiliary memory of said system to said first clock list of said cache memory;
a second data bus adapted to relocate the transferred requested pages into said second clock list upon achieving at least two consecutive cache hits of said transferred requested page;
a cache history comprising pages evicted from said cache memory; and
a controller adapted to vary a proportion of pages marked as said short-term utility and those marked as said long-term utility to increase a cache hit ratio of said cache memory by utilizing the logged history of requested pages.

32. The system of claim 31, wherein said cache memory is arranged into pages having uniformly-sized units of memory.

33. The system of claim 31, wherein said query handler is adapted to determine whether said particular page is located in said cache memory.

34. The system of claim 31, further comprising a bit marker comprising a page reference bit for each page in said cache memory, wherein a new page entering said cache memory comprises a page reference bit of zero, and a page having a cache hit in said cache memory comprises a page reference bit of one.

35. The system of claim 31, further comprising a classifier adapted to identify requested pages located in said auxiliary memory as a cache miss.

36. The system of claim 35, wherein upon identifying said cache miss, said system further comprises a purger adapted to delete a page in either said first clock list or said second clock list if said cache memory is full.

37. The system of claim 35, wherein said cache history comprises a first list of history pages comprising pages evicted from said first clock list; and a second list of history pages comprising pages evicted from said second clock list.

38. The system of claim 37, further comprising:
means for determining whether said requested pages are located in either of said first list of history pages or said second list of history pages;
means for determining whether said cache history is full;
means for evicting a page in said first list of history pages if said transferred requested pages are not located in either of said first list of history pages or said second list of history pages and said cache history is full and a size of said first list of history pages plus a size of said first clock list is equal to a total number of pages in said cache memory; and
means for evicting a page in said second list of history pages if said transferred requested pages are not located in either of said first list of history pages or said second list of history pages and said cache history is full and a size of said first list of history pages plus a size of said first clock list is less than a total number of pages in said cache memory.

39. The system of claim 34, further comprising:
means for identifying requested pages located in said auxiliary memory as a cache miss;
means for inserting a transferred requested page at a most recently used (MRU) position in said first clock list; and
means for setting said page reference bit of said transferred requested page to zero.

40. The system of claim 34, further comprising:
means for logging said history of evicted pages into a cache history of said cache memory, wherein said cache history comprises a first list of history pages and a second list of history pages;
means for determining whether said requested pages are located in said first list of history pages;
means for establishing a target size of said first clock list;
means for increasing said target size of said first clock list upon a determination that said requested pages are located in said first list of history pages;
means for inserting a transferred requested page at a most recently used (MRU) page position in said second clock list upon a determination that said requested page is located in said first list of history pages; and
means for setting said page reference bit of said transferred requested page to zero.

41. The system of claim 34, further comprising:
means for logging said history of evicted pages into a cache history of said cache memory, wherein said cache history comprises a first list of history pages and a second list of history pages;
means for determining whether said requested pages are located in said second list of history pages;
means for establishing a target size of said first clock list;
means for decreasing said target size of said first clock list upon a determination that said requested pages are located in said second list of history pages;
means for inserting a transferred requested page at a most recently used (MRU) page position in said second clock list upon a determination that said requested page is located in said second list of history pages; and
means for setting said page reference bit of said transferred requested page to zero.

42. The system of claim 34, further comprising:
means for logging said history of evicted pages into a cache history of said cache memory, wherein said cache history comprises a first list of history pages and a second list of history pages;
means for identifying a least recently used (LRU) page of said first clock list;
means for evicting said LRU page from said first clock list; and
means for transferring said LRU page to a most recently used (MRU) page position in said first list of history pages if said page reference bit of said LRU page is zero and a size of said first clock list is at least as large as a predetermined target size.

43. The system of claim 34, further comprising:
means for identifying a least recently used (LRU) page of said first clock list;
means for transferring said LRU page from said first clock list to a most recently used (MRU) page position in said second clock list if said page reference bit of said LRU page is one; and
means for resetting said page reference bit to zero.

44. The system of claim 34, further comprising:
means for logging said history of evicted pages into a cache history of said cache memory, wherein said cache history comprises a first list of history pages and a second list of history pages;
means for identifying a least recently used (LRU) page of said second clock list;
means for evicting said LRU page from said second clock list; and
means for transferring said LRU page to a most recently used (MRU) page position in said second list of history pages if said page reference bit of said LRU page is zero and a size of said first clock list is smaller than a predetermined target size.

45. The system of claim 34, further comprising:
means for identifying a least recently used (LRU) page of said second clock list; and
means for transferring said LRU page from said second clock list to a most recently used (MRU) page position in said second clock list if said page reference bit of said LRU page is one.

46. A system of managing data retrieval in a computer comprising a cache memory and an auxiliary memory, said system comprising:
means for organizing pages in said cache memory into a first clock list and a second clock list, wherein said first clock list comprises pages with short-term utility and said second clock list comprises pages with long-term utility;
means for requesting retrieval of a particular page in said computer system;
means for identifying requested pages located in said cache memory as a cache hit;
means for transferring requested pages located in said auxiliary memory to said first clock list of said cache memory;
means for relocating the transferred requested pages into said second clock list upon achieving at least two consecutive cache hits of said transferred requested page;
means for logging a history of pages evicted from said cache memory; and
means for adaptively varying a proportion of pages marked as said short-term utility and those marked as said long-term utility to increase a cache hit ratio of said cache memory by utilizing the logged history of evicted pages.
